(19) United States
(12) Patent Application Publication
(10) Pub. No.: US 2013/0052301 A1
(43) Pub. Date: Feb. 28, 2013

(54) CHEWING GUM COMPOSITIONS

(71) Applicants: Leslie D. Morgret, Evanston, IL (US); Michael S. Haas, Naperville, IL (US); Xiaohu Xia, Evanston, IL (US); Marc A. Hillmyer, Minneapolis, MN (US); Mark T. Martello, Saint Paul, MN (US); Christopher Macosko, Minneapolis, MN (US); Luca Martinetti, Minneapolis, MN (US); Frank S. Bates, Saint Louis Park, MN (US); Sangwoo Lee, Minneapolis, MN (US); Michael Bunczek, Lisle, IL (US); Michael T. Greenberg, NorthBrook, IL (US)

(72) Inventors: Leslie D. Morgret, Evanston, IL (US); Michael S. Haas, Naperville, IL (US); Xiaohu Xia, Evanston, IL (US); Marc A. Hillmyer, Minneapolis, MN (US); Mark T. Martello, Saint Paul, MN (US); Christopher Macosko, Minneapolis, MN (US); Luca Martinetti, Minneapolis, MN (US); Frank S. Bates, Saint Louis Park, MN (US); Sangwoo Lee, Minneapolis, MN (US); Michael Bunczek, Lisle, IL (US); Michael T. Greenberg, NorthBrook, IL (US)

(21) Appl. No.: 13/394,658

(22) PCT Filed: Sep. 10, 2010
(86) PCT No.: PCT/US10/48508

§ 371 Date: Oct. 22, 2012

Related U.S. Application Data
(60) Provisional application No. 61/241,080, filed on Sep. 10, 2009.

(51) Int. Cl. A23G 4/20

(52) U.S. Cl. 426/4; 426/5

(57) ABSTRACT

A chewing gum base which is cud-forming and chewable at mouth temperature contains a food acceptable tri-block copolymer having the form A-B-A or A-B-C and comprising a soft mid-block which constitutes at least 30 wt. % of the total polymer and hard end-blocks each having a glass transition temperature below 70° C. The tri-block copolymer is optionally plasticized with a compatible di-block copolymer to function as an elastomer system in the gum base.

### CROSS-REFERENCE TO RELATED APPLICATIONS

This application claims benefit to U.S. Provisional Application No. 61/241,080 filed Sep. 10, 2009, incorporated by reference herein.

### BACKGROUND OF THE INVENTION

The present invention relates to chewing gum. More specifically, this invention relates to improved formulations for chewing gum bases and chewing gums containing tri-block copolymers of the form A-B-A or A-B-C which form cuds having improved removability from environmental surfaces as compared to most commercial chewing gums.

The fundamental components of a chewing gum typically are a water-insoluble gum base portion and a water-soluble bulking agent portion. The primary component of the gum base is an elastomeric polymer which provides the characteristic chewy texture of the product. The gum base will typically include other ingredients which modify the chewing properties or aid in processing the product. These include plasticizers, softeners, fillers, emulsifiers, plastic resins, as well as colorants and antioxidants. The water soluble portion of the chewing gum typically includes a bulking agent together with minor amounts of secondary components such as flavors, high-intensity sweeteners, colorants, water-soluble softeners, gum emulsifiers, acidulants and sensates. Typically, the water-soluble portion, sensates, and flavors dissipate during chewing and the gum base is retained in the mouth throughout the chew.

One problem with traditional gum bases is the nuisance of gum litter when chewed gum cuds are improperly discarded. While consumers can easily dispose of chewed cuds in waste receptacles, some consumers intentionally or accidentally discard cuds onto sidewalks and other environmental surfaces. The nature of conventional gum bases can cause the improperly discarded cuds to adhere to the environmental surface and subsequently to be trampled by foot traffic into a flattened embedded mass which can be extremely difficult to remove.

This invention is directed to novel gum bases comprising food acceptable tri-block copolymers having the form A-B-A or A-B-C and consumer-acceptable chewing gums containing such gum bases which provide for reduced adhesion to environmental surfaces when compared to most commercially available chewing gums.

### SUMMARY OF THE INVENTION

A chewing gum contains a water-insoluble gum base portion containing a tri-block copolymer having the form A-B-A or A-B-C, the copolymer having a soft mid-block and hard end-blocks wherein the soft mid-block comprises at least 50 wt. % of the tri-block copolymer and wherein the hard end-blocks each have a T_{g} below 70° C. wherein the gum base is cud-forming and chewable at mouth temperature.

### BRIEF DESCRIPTION OF THE DRAWINGS

FIG. 1a is a graphic illustration of possible internal structures of triblock copolymers.

FIG. 1b is a series of small angle X-ray scattering patterns confirming existence of internal structure in selected polymer examples.

FIG. 2 is a graph of small angle oscillatory shear curves at 37° C. demonstrating the effect of PLA weight fraction on a PLA-P(6-MCL)-PLA triblock copolymer having a P(6-MCL) mid-block of 20 kDa.

FIG. 3 is a Differential Scanning Calorimetry thermograph of Tri-Block Copolymers described in Examples 3, 6, 7, 8, 9, 11 and 12.

FIG. 4 is a DSC thermograph for Example 15 after having been finger chewed for 20 minutes and aged at 45° C. for 24 hours.

FIG. 5 is plots of small amplitude oscillatory shear rheology of Example 18.

FIG. 6 is a Size Exclusion Chromatogram of Example 18

FIG. 7 is an NMR spectrogram of Example 18

FIG. 8 is a Differential Scanning Calorimetry thermograph of Example 18.

FIG. 9 is a graph of sensory panelist ratings of Firmness for Examples 29-31 versus a commercial control chewing gum over a 20 minute chew

FIG. 10 is a graph of sensory panelist ratings of Squeakiness for Examples 29-31 and Comparative Run 32 over a 20 minute chew.

FIG. 11 is a graph of sensory panelist ratings of Flavor Intensity for Examples 29-31 and Comparative Run 32 over a 20 minute chew.

FIG. 12 is a graph of sensory panelist ratings of Sweetness Intensity for Examples 29-31 and Comparative Run 32 over a 20 minute chew.

### DESCRIPTION OF THE INVENTION

The present invention provides improved chewing gum formulations and chewing gum bases, as well as methods of producing chewing gum and chewing gum bases. In accordance with the present invention, novel chewing gum bases and chewing gums are provided that include a tri-block copolymer of the form A-B-A or A-B-C comprising two hard end-blocks and a soft mid-block wherein the soft mid-block comprises at least 30% by weight of the copolymer and wherein the hard end-blocks each have a glass transition temperature (T_{g}) less than 70° C.

A variety of gum base and chewing gum formulations including the tri-block copolymers of the present invention can be created and/or used. In some embodiments, the present invention provides for gum base formulations which are conventional gum bases that include wax or are wax-free. In some embodiments, the present invention provides for chewing gum formulations that can be low or high moisture formulations containing low or high amounts of moisture-containing syrup. Low moisture chewing gum formulations are those which contain less than 1.5% or less than 1% or even less than 0.5% water. Conversely, high moisture chewing gum formulations are those which contain more than 1.5% or more than 2% or even more than 2.5% water. The tri-block copolymers of the present invention can be used in sugar-containing chewing gums and also in low sugar and non-sugar containing gum formulations made with sorbitol, mannitol, other polyols, and non-sugar carbohydrates.

In some embodiments, a tri-block copolymer of the present invention may be used as the sole elastomer or it may be combined with other base elastomers for use in chewing gum base. Such other elastomers, where used; include synthetic elastomers including polyisobutylene, isobutylene-isoprene copolymers, styrene-butadiene copolymers, polyisoprene, polyolefin thermoplastic elastomers such as ethylene-propylene copolymer and ethylene-octene copolymer and combinations thereof. Natural elastomers that can be used include natural rubbers such as chicle and proteins such as zein or gluten. In some embodiments, the tri-block copolymers may be blended with removable or environmentally degradable homopolymers such as polylactides, and polyesters prepared from food acceptable acids and alcohols. However, it is preferred that the tri-block copolymers of the present invention constitute the sole elastomers used in the gum base.

It is important that the triblock copolymers of the present invention be food grade. While requirements for being food grade vary from country to country, food grade polymers intended for use as masticatory substances (i.e. gum base) will typically have to meet one or more of the following criteria. They may have to be approved by local food regulatory agencies for this purpose. They may have to be manufactured under “Good Manufacturing Practices” (GMPs) which may be defined by local regulatory agencies, such practices ensuring adequate levels of cleanliness and safety for the manufacturing of food materials. Materials (including reagents, catalysts, solvents and antioxidants) used in the manufacture will desirably be food grade (where possible) or at least meet strict standards for quality and purity. The finished product may have to meet minimum standards for quality and the level and nature of any impurities present, including residual monomer content. The manufacturing history of the material may be required to be adequately documented to ensure compliance with the appropriate standards. The manufacturing facility itself may be subject to inspection by governmental regulatory agencies. Again, not all of these standards may apply in all jurisdictions. As used herein, the term “food grade” will mean that the triblock copolymers meet all applicable food standards in the locality where the product is manufactured and/or sold.

In some embodiments of this invention, the tri-block copolymer is combined with a di-block copolymer comprising a soft block and a hard block which are compatible with the soft and at least one of hard blocks respectively in the tri-block copolymer. In these embodiments, the di-block copolymer plasticizes the tri-block copolymer to provide a plasticized elastomer material which is consistent with the chew properties of conventional elastomer/plasticizer systems. The di-block plasticizer may also provide additional benefits such as controlling release of flavors, sweeteners and other active ingredients, and reducing surface interactions of discarded cuds for improved removability from environmental surfaces.

By compatible, it is meant that the component polymers (when separate from the tri-block or di-block configuration) have a chemical affinity and can form a miscible mixture which is homogeneous on the microdomain scale. This can normally be determined by a uniform transparent appearance. In cases where uncertainty exists, it may be helpful to stain one of the polymers in which case the mixture will, when examined with microscopic methods, have a uniform color if the polymers are compatible or exhibit swirls or a mottled appearance if the polymers are incompatible. Compatible polymers typically have similar solubility parameters as determined empirically or by computational methods. In preferred embodiments, the hard and soft blocks which comprise the tri-block copolymer will be essentially identical to those of the di-block copolymer to ensure the greatest possible compatibility. Further information on polymer compatibility may be found in Pure & Appl. Chem., Vol 58, No. 12, pp 1553-1560, 1986 (Krause) which is incorporated by reference herein.

The tri-block copolymers of the present invention typically are elastomeric at mouth temperature in the sense of having an ability to be stretched to at least twice of an original length and to recover substantially to such original length (such as no more than 150%, preferably no more than 125% of the original length) upon release of stress. Preferably, the polymer will also be elastomeric at room temperature and even lower temperatures which may be encountered in the outdoor environment.

In preferred embodiments of the present invention, cuds formed from gum bases containing tri-block copolymers are readily removable from concrete if they should become adhered to such a surface. By readily removable from concrete, it is meant that the cuds which adhere to concrete can be removed with minimal effort leaving little or no adhering residue. For example, readily removable cuds may be removable by use of typical high pressure water washing apparatuses in no more than 20 seconds leaving no more than 20% residue based on the original area covered by the adhered cud. Alternatively, a readily removable cud may be peeled off of a concrete surface by grasping and pulling with fingers leaving no more than 20% residue by area of the original cud. Alternatively, a more formal test can be conducted as follows. Two grams of gum is chewed or manually kneaded under water for 20 minutes to produce a cud. The cud is then immediately placed on a concrete paver stone and covered with silicone coated paper. 150 to 200 pounds of pressure is applied to the cud (for example by stepping on it with a flat soled shoe) for approximately two seconds. The silicone-coated paper is then removed and the adhered cud and paver stone are conditioned at 45° C./60% RH for 48 hours. A flat-edged metal scraper held at a 15° angle is used to make a single scrape of the cud over approximately three to five seconds. The results are then evaluated using image analysis software, such as ImageJ 1.41o from the National Institutes of Health, to measure the portion of the cud remaining. Readily removable cuds will leave no more than 20% of the original mass as residue and require no more than approximately 50 N of force. Of course, it is desirable that the cud leave even less residue and require less force to remove.

In some embodiments, the tri-block copolymer or tri-block/di-block copolymer blend (hereinafter the tri-block elastomer system) will be the sole component of the insoluble gum base. In other embodiments, the tri-block copolymer or tri-block elastomer system will be combined with softeners, fillers, colors, antioxidants and other conventional, non-elastomeric gum base components. In some embodiments, the tri-block copolymer or tri-block elastomer system gum bases may be used to replace conventional gum bases in chewing gum formulas which additionally contain water-soluble bulking agents, flavors, high-intensity sweeteners, colors, pharmaceutical or nutraceutical agents and other optional ingredients. These chewing gums may be formed into sticks, tabs, tapes, coated or uncoated pellets or balls or any other desired form. By substituting the tri-block copolymer or tri-block elastomer system of the present invention for a portion or all of the conventional gum base elastomers, consumer-acceptable chewing gum products can be manufactured which exhibit reduced adhesion to environmental surfaces, especially concrete.

In order to further enhance the removability of cuds formed from gum bases comprising the triblock copolymer systems of the present invention, it may be desirable to incorporate other known removability-enhancing features into the chewing gum or gum base. For example, certain additives such as emulsifiers and amphiphilic polymers may be added. Another additive which may prove useful is a polymer having a straight or branched chain carbon-carbon polymer backbone and a multiplicity of side chains attached to the backbone as disclosed in WO 06-016179. Still another additive which may enhance removability is a polymer comprising hydrolyzable units or an ester and/or ether of such a polymer. One such polymer comprising hydrolyzable units is a copolymer sold under the Trade name Gantrez®. Addition of such polymers at levels of 1 to 20% by weight of the gum base may reduce adhesion of discarded gum cuds. These polymers may also be added to the gum mixer at a level of 1 to 7% by weight of the chewing gum composition.

Another gum base additive which may enhance removability of gum cuds is high molecular weight polyvinyl acetate having a molecular weight of 100,000 to 600,000 daltons as disclosed in US 2003/0198710. This polymer may be used at levels of 7 to 70% by weight of the gum base.

Another approach to enhancing removability of the present invention involves formulating gum bases to contain less than 5% (i.e. 0 to 5%) of a calcium carbonate and/or talc filler and/or 5 to 40% amorphous silica filler. Formulating gum bases to contain 5 to 15% of high molecular weight polyisobutylene (for example, polyisobutylene having a weight average or number average molecular weight of at least 200,000 Daltons) is also effective in enhancing removability. High levels of emulsifiers such as powdered lecithin may be incorporated into the chewing gum at levels of 3 to 7% by weight of the chewing gum composition. It may be advantageous to spray dry or otherwise encapsulate the emulsifier to delay its release. Any combination of the above approaches may be employed simultaneously to achieve improved removability. Specifically, removability can be enhanced by incorporating a triblock copolymer or tri-block elastomer system as previously described into a gum base having 0 to 5% of a calcium carbonate or talc filler, 5 to 40% amorphous silica filler, 5 to 15% high molecular weight polyisobutylene, 1 to 20% of a polymer having a straight or branched chain carbon-carbon polymer backbone and a multiplicity of side chains attached to the backbone and further incorporating this gum base into a chewing gum comprising 3 to 7% of an emulsifier, such as lecithin, which is preferably encapsulated such as by spray drying. Many variations on this multi-component solution to the cud adhesion problem can be employed. For example, the polymer having a straight or branched chain carbon-carbon polymer backbone or the ester and/or ether of a polymer comprising hydrolyzable units may be added to the gum mixer instead of incorporating it into the gum base, in which case it may be employed at a level of 1 to 7% of the chewing gum composition. Also, in some cases it may be desirable to omit one or more of the above components for various reasons.

The tri-block copolymer or tri-block elastomer system, when used according to the present invention, affords the chewing gum consumer acceptable texture, shelf life and flavor quality. Because the tri-block copolymer or tri-block elastomer systems have chewing properties similar to other elastomers in most respects, gum bases containing them create a resultant chewing gum product that has a high consumer-acceptability.

The present invention provides in some embodiments gum base and chewing gum manufacturing processes which have improved efficiency as compared with conventional processes.

Additional features and advantages of the present invention are described in, and will be apparent from, the detailed description of the presently preferred embodiments.

Tri-block copolymers of the present invention have a soft mid-block polymer covalently bonded to two hard end-block polymers in an A-B-A or A-B-C configuration. By a soft mid-block it is meant that the middle or “B” block is composed of a polymer having a glass transition temperature substantially below mouth temperature. Specifically, the polymer comprising the soft block will have a T_{g} below 20° C. Preferably, the polymer comprising the soft block will have a T_{g} below 10° C. Even more preferably, the polymer comprising the soft block will have a T_{g} below 0° C. Soft polymers will also have a complex shear modulus between 10³ and 10⁸ Pascals at 37° C. and 1 rad/sec. Preferably, the shear modulus will be between 10⁴ and 10⁷ more preferably between 5×10⁵ and 5×10⁶ at 37° C. and 1 rad/sec. In an embodiment, the soft mid-block comprises polyisoprene. In an embodiment, the soft mid-block comprises poly(6-methylcaprolactone). In an embodiment, the soft mid-block comprises poly(6-butyl-ε-caprolactone). In an embodiment, the soft mid-block comprises other polymers of alkyl or aryl substituted ε-caprolactones. In an embodiment, the soft mid-block comprises polydimethylsiloxane. In an embodiment, the soft mid-block comprises polybutadiene. In an embodiment, the soft mid-block comprises polycyclooctene. In an embodiment, the soft mid-block comprises polyvinyllaurate. In an embodiment, the soft mid-block comprises polyethylene oxide. In an embodiment, the soft mid-block comprises polyoxymethylene. In an embodiment, the soft mid-block comprises polymenthide. In an embodiment, the soft mid-block comprises polyfarnesene. In an embodiment, the soft mid-block comprises polymyrcene. In some embodiments, the soft mid-block may be a random or alternating copolymer. Generally, the soft mid-block will be non-crystalline at typical storage and mouth temperatures. However, it may be acceptable for the soft mid-block to have some semi-crystalline domains.

By hard end-blocks, it is meant that the end or “A” and/or C block(s) comprise essentially identical polymers (in the case of the A-B-A form) or compatible or incompatible polymers (in the case of the A-B-C form) having a T_{g}. above about 20° C. Preferably, the polymer(s) comprising the hard end-blocks will have a T_{g} above 30° C. or even above 40° C. In the present invention, it is also important that the hard polymer(s) have a T_{g} sufficiently low as to allow convenient and efficient processing, especially when the tri-block copolymer or tri-block elastomer system is to be used as the sole component in a gum base. Thus the hard polymer(s) should have a T_{g} below 70° C. and preferably below 60° C. In an embodiment, the hard polymer(s) will have a T_{g} between 20° C. and 70° C. In an embodiment, the hard polymer(s) will have a T_{g} between 20° C. and 60° C. In an embodiment, the hard polymer(s) will have a T_{g} between 30° C. and 70° C. In an embodiment, the hard polymer(s) will have a T_{g} between 30° C. and 60° C. In an embodiment, the hard polymer(s) will have a T_{g} between 40° C. and 70° C. In an embodiment, the hard polymer(s) will have a T_{g} between 40° C. and 60° C. Use of hard polymers having this T_{g} range allows lower processing temperatures, reduced mixing torque and shorter mixing times. This results in energy savings and effectively increased mixing capacity. In continuous mixing extruders the problem of excess heat buildup is reduced. In an embodiment, the hard end-block comprises polylactide (PLA). In an embodiment, the hard end-block comprises polyvinylacetate. In an embodiment, the hard end-block comprises polyethylene terephthalate. In an embodiment, the hard end-block comprises polyglycolic acid. In an embodiment, the hard end-block comprises poly(propyl methacrylate). In some embodiments, the hard end-blocks may be random or alternating copolymers such as a random or alternating copolymer of glycolic acid and D,L lactide. Typically, the hard end-blocks will be amorphous or semi-crystalline at storage and chewing temperatures.

It is preferred that the soft mid-block and hard end-blocks be incompatible with each other to maximize the formation of internal microdomains as described below. Methods of testing for compatibility are also described below.

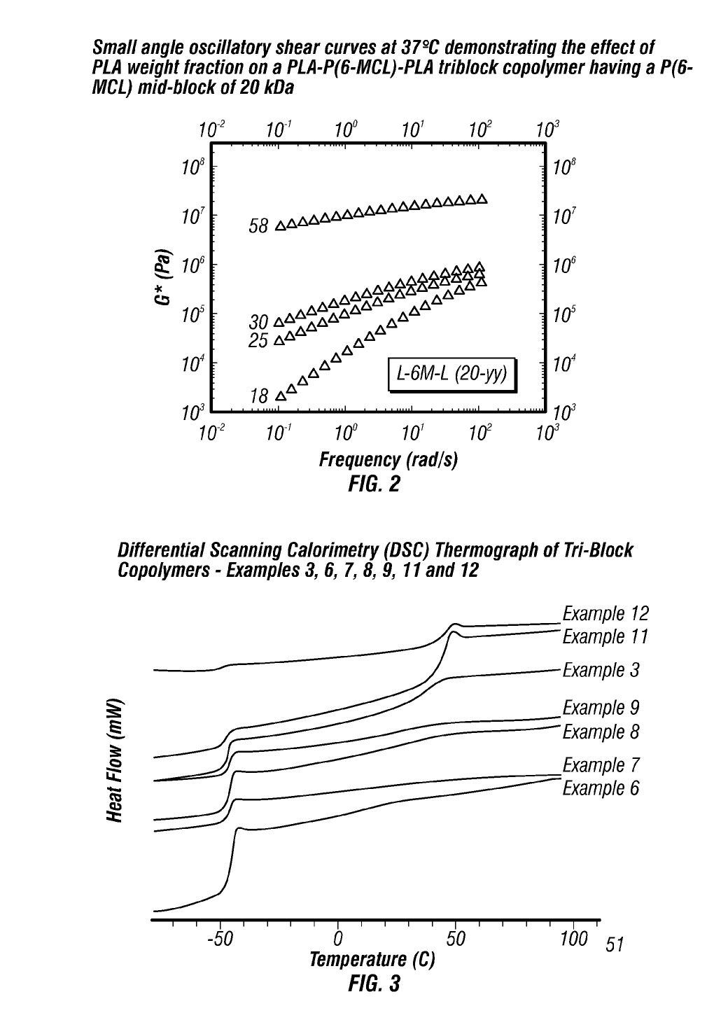

Glass transition temperatures of the hard and soft blocks can be conventionally measured using Differential Scanning Calorimetry (DSC) as is well known in the art. Triblock copolymers of the present invention will have DSC thermographs which display two (or possibly three in the case of A-B-C tri-block copolymers) glass transitions; a low temperature transition corresponding to the T_{g} of the soft block and one or two high temperature transitions corresponding to the T_{g} of the hard blocks. (See FIG. 3) In some cases it may be difficult to detect the hard-block transition(s), particularly when the soft block greatly exceeds 50% of the total mass of the polymer. In such cases, a homopolymer of one or both blocks may be synthesized to a similar molecular weight and tested by DSC to determine the T_{g}.

In the tri-block copolymers of the present invention, the soft mid-block will constitute at least 30%, preferably at least 40% or at least 50% or at least 60% by weight of the total polymer. This insures that the polymer will provide the elasticity necessary to function as an elastomer in the gum base. The remainder of the tri-block copolymer will comprise the hard end-blocks. Thus, the combined weight of the two end-blocks will be less than 70% and preferably less than 60% or 50% or 40% by weight of the total polymer.

In most cases, particularly when the tri-block copolymer has an A-B-A configuration, the two hard end-blocks will be of approximately equal molecular weight. That is, the ratio of their molecular weights will be between 0.8:1 and 1:1. However, it is also contemplated that they may be of substantially unequal lengths such as 0.75:1 or 0.70:1 or 0.60:1 or even 0.50:1 or 0.30:1, particularly when the triblock copolymer has an A-B-C configuration.

The molecular weight of the tri-block copolymer will be selected to provide the desired textural properties when incorporated into a chewing gum base or chewing gum. The optimal molecular weight for this purpose will vary depending upon the specific polymeric blocks chosen and the composition of the gum base or gum product, but generally it will fall into the range of 6,000 to 400,000 daltons. More typically, it will fall into the range of 20,000 to 150,000 daltons. Tri-block copolymers with excessive molecular weight will be too firm to chew when incorporated into gum base and chewing gum compositions. In addition, they may be difficult to process. Tri-block copolymers with insufficient molecular weight may lack proper chewing cohesion, firmness and elasticity for chewing and may additionally pose regulatory and food safety concerns.

Typically, A-B-A tri-block copolymers of the present invention will be prepared by first polymerizing the soft mid-block polymer from one or more suitable monomer reagents. This polymerization may be carried out by any appropriate polymerization reaction such as ring opening polymerization, ring opening metasticization polymerization (ROMP), free radical polymerization, condensation polymerization, living polymerization, anionic polymerization, or cationic polymerization. Once the soft mid-block polymer has achieved the desired molecular weight, one or more monomers appropriate for polymerization of the hard end-block polymer(s) will be introduced and allowed to react to build the end-block chains on each end of the mid-block. Optionally, once the mid-block reaches the desired molecular weight, it may be terminated and purified prior to addition of the end-block monomer(s). Once the end-blocks have achieved the desired molecular weight, the reaction is terminated. Of course, appropriate reaction conditions and catalysts will be used throughout the process. Alternatively, any process effective to produce a tri-block copolymer having the above identified attributes may be employed.

A-B-C triblock copolymers are typically synthesized via a sequential block copolymerization. Specifically, if the B block is first polymerized via a typical polymerization method in the art (living, anionic, cationic, free-radical, etc.) then it will typically be capped and have one end functionalized to promote polymerization of either the A or C end-block in the next polymerization sequence. After polymerization of the next block, the A or C end-block is typically terminated to prevent further reactions while the other end of the B block is then uncapped and functionalized for the final polymerization sequence. From there, a method commonly used in the art may be utilized to polymerize and ultimately terminate the remaining end-block to complete the polymerization of an A-B-C triblock copolymer. Alternatively, any variance of a sequential block copolymerization where either the A, B, or C block is polymerized first followed by the remaining block could be employed. Additionally, any polymerization method used in the art to prepare A-B diblock copolymers could be used as well before functionalizing one end to make an A-B-C triblock copolymer. One such A-B-C triblock copolymer which can be made by the above methods is Poly(lactic acid)-Poly(methyl caprolactone)-Poly(propyl methacrylate) or PLA-PMCL-PPMA.

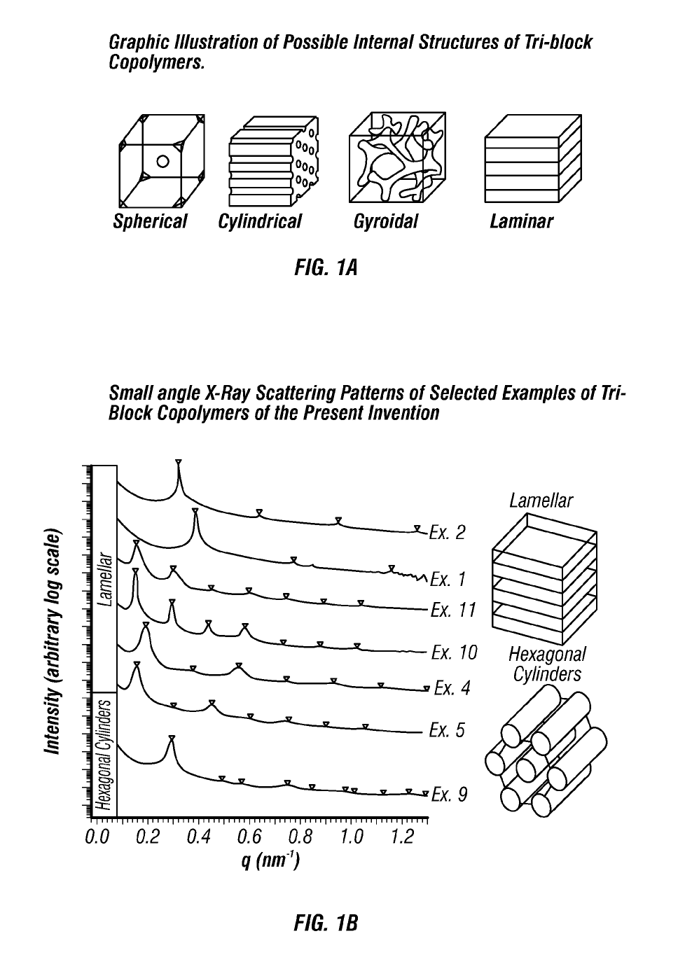

The tri-block copolymers of the present invention, when incorporated into gum bases and chewing gums and chewed, produce cohesive cuds which are more easily removed from environmental surfaces if improperly discarded. Cohesive cuds, that is, cuds which display a high degree of self adhesion, tend to contract and curl away from attached surfaces such as concrete. In the case of the tri-block copolymers of the present invention, it is believed that this cohesiveness is due to the formation of internal structures which increase the cohesivity of the cud. These internal structures are caused by microphase domain separation and subsequent ordering of the hard and soft domains of the polymer molecules. Depending on the weight ratio of soft to hard blocks, lamellar, cylindrical, spherical or gyroidal and/or other microdomain structures may predominate in the polymer matrix, although smaller levels of the other structural domains will likely exist concurrently. It may be difficult to determine which structure predominates in any given system and even small changes in the ratio of soft to hard blocks may produce disproportionate changes in texture due to this phenomenon. This provides a means of adjusting the texture significantly, though perhaps not linearly, by adjusting the ratio up or down. Graphic illustrations of the possible internal structures are shown in FIG. 1a. FIG. 1b shows the results of small angle X-ray scattering of selected polymer examples. The presence of peaks in the pattern confirm that internal structures exist in the polymers.

In some embodiments, the tri-block copolymers of the present invention and the gum bases prepared from them, produce gum cuds which are environmentally degradable. By environmentally degradable, it is meant that the polymer can be broken into smaller segments by environmental forces such as microbial action, hydrolytic action, oxidation, UV light or consumption by insects. This further reduces or eliminates the aforementioned nuisance of improperly discarded gum cuds. In some embodiments, the tri-block copolymers of the present invention are produced from sources other than petroleum feed stocks for enhanced sustainability and to avoid consumer concerns regarding the use of petroleum derived materials in chewing gum products. In some embodiments, the monomers used to produce the tri-block copolymers, for example D,L-lactide, farnesene, myrcene and isoprene, are or can be produced from renewable resources, typically agricultural crops, trees and natural vegetation.

When used to formulate a gum base of the present invention, it is preferred that the tri-block copolymers of the present inventions be plasticized with a suitable plasticizing agent. One preferred plasticizing agent is a di-block copolymer having a soft block and a hard block which are compatible with those of the tri-block copolymer It is preferred that the soft and hard blocks of the di-block copolymer be composed of the same polymers used in the tri-block copolymer. However, other compatible polymers may also be used. It is preferred that the di-block copolymer blocks have no more than roughly half the molecular weight of the corresponding blocks in the tri-block copolymer which the di-block copolymer is plasticizing.

When a tri-block copolymer and a di-block copolymer are used in a tri-block elastomer system, it is preferred that the two components be used in a ratio of from 1:99 to 99:1 and more preferably 40:60 to 80:20 di-block:tri-block to assure that the resulting tri-block elastomer system will have proper texture for processing and chewing. The tri-block copolymers may also be plasticized with a conventional plasticizing agent to form an elastomeric material which, when formulated as a gum base, has sufficient chewing cohesion to be cud-forming and chewable at mouth temperatures. Plasticizers typically function to lower the T_{g} of a polymer to make the gum cud chewable at mouth temperature. Suitable plasticizers typically are also capable of decreasing the shear modulus of the base. Suitable plasticizing agents are substances of relatively low molecular weight which have a solubility parameter similar to the polymer so they are capable of intimately mixing with the polymer and reducing the T_{g} of the mixture to a value lower than the polymer alone. Generally, any food acceptable plasticizer which functions to soften the tri-block copolymer and render it chewable at mouth temperature will be a suitable plasticizer. Plasticizers which may be used in the present invention include triacetin, phospholipids such as lecithin and phosphatidylcholine, triglycerides of C₄-C₆ fatty acid such as glycerol trihexanoate, polyglycerol, polyricinoleate, propylene glycol di-octanoate, propylene glycol di-decanoate, triglycerol penta-caprylate, triglycerol penta-caprate, decaglyceryl hexaoleate, decaglycerol decaoleate, citric acid esters of mono- or di-glycerides, polyoxyethylene sorbitan such as POE (80) sorbitan monolaurate, POE (20) sorbitan monooleate, rosin ester and polyterpene resin.

Fats, waxes and acetylated monoglycerides can enhance the effect of the suitable plasticizers when incorporated into the gum bases of the present invention. However, fats and waxes may not be suitable for use as the sole plasticizers in these compositions.

It is preferred that the tri-block copolymer be preblended with the di-block copolymer or other plasticizer, for example by blending in a solvent, or by using mechanical blending at temperatures above the glass transition temperature of the hard polymer blocks or by polymerizing the di- and tri-block copolymers together.

The water-insoluble gum base of the present invention may optionally contain conventional petroleum-based elastomers and elastomer plasticizers such as styrene-butadiene rubber, butyl rubber, polyisobutylene, terpene resins and estergums. Where used, these conventional elastomers may be combined in any compatible ratio with the tri-block copolymer. In a preferred embodiment, significant amounts (more than 1 wt. %) of these conventional elastomers and elastomer plasticizers are not incorporated into a gum base of the present invention. In other preferred embodiments, less than 15 wt. % and preferably less than 10 wt. % and more preferably less than 5 wt. % of petroleum-based elastomers and elastomer plasticizers are contained in the gum base of the present invention. Other ingredients which may optionally be employed include inorganic fillers such as calcium carbonate and talc, emulsifiers such as lecithin and mono- and di-glycerides, plastic resins such as polyvinyl acetate, polyvinyl laurate, and vinylacetate/vinyl laurate copolymers, colors and antioxidants.

The water-insoluble gum base of the present invention may constitute from about 5 to about 95% by weight of the chewing gum. More typically it may constitute from about 10 to about 50% by weight of the chewing gum and, in various preferred embodiments, may constitute from about 20 to about 35% by weight of the chewing gum.

A typical gum base useful in this invention includes about 5 to 100 wt. % plasticized tri-block copolymer elastomer, 0 to 20 wt. % synthetic elastomer, 0 to 20 wt. % natural elastomer, about 0 to about 40% by weight elastomer plasticizer, about 0 to about 35 wt. % filler, about 0 to about 35 wt. % softener, and optional minor amounts (e.g., about 1 wt. % or less) of miscellaneous ingredients such as colorants, antioxidants, and the like.

Further, a typical gum base includes at least 5 wt. % and more typically at least 10 wt. % softener and includes up to 35 wt. % and more typically up to 30 wt. % softener. Still further, a typical gum base includes 5 to 40 wt. % and more typically 15 to 30 wt. % hydrophilic modifier such as polyvinylacetate. Minor amounts (e.g., up to about 1 wt. %) of miscellaneous ingredients such as colorants, antioxidants, and the like also may be included into such a gum base.

In an embodiment, a chewing gum base of the present invention contains about 4 to about 35 weight percent filler, about 5 to about 35 weight percent softener, about 5 to about 40% hydrophilic modifier and optional minor amounts (about one percent or less) of miscellaneous ingredients such as colorants, antioxidants, and the like.

Additional elastomers may include, but are not limited to, polyisobutylene having a viscosity average molecular weight of about 100,000 to about 800,000, isobutylene-isoprene copolymer (butyl elastomer), polyolefin thermoplastic elastomers such as ethylene-propylene copolymer and ethylene-octene copolymer, styrene-butadiene copolymers having styrene-butadiene ratios of about 1:3 to about 3:1 and/or polyisoprene, and combinations thereof. Natural elastomers which may be similarly incorporated into the gum bases of the present inventions include jelutong, lechi caspi, perillo, sorva, massaranduba balata, massaranduba chocolate, nispero, rosindinha, chicle, gutta hang kang, and combinations thereof.

The elastomer component of gum bases used in this invention may contain up to 100 wt. % tri-block copolymer. In some embodiments, the tri-block copolymers of the present invention may be combined with compatible plasticizers (including di-block copolymers as previously described) and the plasticized copolymer system may be used as the sole components of a gum base. Alternatively, mixtures of plasticized or unplasticized tri-block copolymers with other elastomers also may be used. In such embodiments, mixtures with conventional elastomeric components of gum bases may comprise least 10 wt. % plasticized or unplasticized tri-block copolymer, typically at least 30 wt. % and preferably at least 50 wt. % of the elastomer. In order to provide for improved removability of discarded gum cuds form environmental surfaces, gum bases of the present invention will contain an elastomeric component which comprises at least 10%, preferably at least 30%, more preferably at least 50% and up to 100 wt. % plasticized or unplasticized tri-block copolymer in addition to other non-elastomeric components which may be present in the gum base. Due to cost limitations, processing requirements, sensory properties and other considerations, it may be desirable to limit the elastomeric component of the gum base to no more than 90%, or 75% or 50% plasticized or unplasticized tri-block copolymer.

A typical gum base containing tri-block copolymers of the present invention may have a complex shear modulus (the measure of the resistance to the deformation) of 1 kPa to 10,000 kPa at 40° C. (measured on a Rheometric Dynamic Analyzer with dynamic temperature steps, 0-100° C. at 3° C./min; parallel plate; 0.5% strain; 10 rad/sec). Preferably, the complex shear modulus will be between 10 kPa and 1000 kPa at the above conditions. Gum bases having shear modulus in these ranges have been found to have acceptable chewing properties.

A suitable tri-block copolymer used in this invention typically should be free of strong, undesirable off-tastes (i.e. objectionable flavors which cannot be masked) and have an ability to incorporate flavor materials which provide a consumer-acceptable flavor sensation. Suitable tri-block copolymers should also be safe and food acceptable, i.e. capable of being food approved by government regulatory agencies for use as a masticatory substance, i.e. chewing gum base. Furthermore, it is preferable that the polymers be prepared using only food safe catalysts, reagents and solvents.

Typically, the tri-block copolymers of the present invention have sufficient chewing cohesion such that a chewing gum composition containing such material forms a discrete gum cud with consumer acceptable chewing characteristics.

Elastomer plasticizers commonly used for petroleum-based elastomers may be optionally used in this invention including but are not limited to, natural rosin esters, often called estergums, such as glycerol esters of partially hydrogenated rosin, glycerol esters of polymerized rosin, glycerol esters of partially or fully dimerized rosin, glycerol esters of rosin, pentaerythritol esters of partially hydrogenated rosin, methyl and partially hydrogenated methyl esters of rosin, pentaerythritol esters of rosin, glycerol esters of wood rosin, glycerol esters of gum rosin; synthetics such as terpene resins derived from alpha-pinene, beta-pinene, and/or d-limonene; and any suitable combinations of the foregoing. The preferred elastomer plasticizers also will vary depending on the specific application, and on the type of elastomer which is used.

In addition to natural rosin esters, also called resins, elastomer solvents may include other types of plastic resins. These include polyvinyl acetate having a GPC weight average molecular weight of about 2,000 to about 90,000, polyethylene, vinyl acetate-vinyl laurate copolymer having vinyl laurate content of about 5 to about 50 percent by weight of the copolymer, and combinations thereof. Preferred weight average molecular weights (by GPC) for polyisoprene are 50,000 to 80,000 and for polyvinyl acetate are 10,000 to 65,000 (with higher molecular weight polyvinyl acetates typically used in bubble gum base). For vinyl acetate-vinyl laurate, vinyl laurate content of 10-45 percent by weight of the copolymer is preferred. Preferably, a gum base contains a plastic resin in addition to other materials functioning as elastomer plasticizers.

Additionally, a gum base may include fillers/texturizers and softeners/emulsifiers. Softeners (including emulsifiers) are added to chewing gum in order to optimize the chewability and mouth feel of the gum.

Softeners/emulsifiers that typically are used include tallow, hydrogenated tallow, hydrogenated and partially hydrogenated vegetable oils, cocoa butter, mono- and di-glycerides such as glycerol monostearate, glycerol triacetate, lecithin, paraffin wax, microcrystalline wax, natural waxes and combinations thereof. Lecithin and mono- and di-glycerides also function as emulsifiers to improve compatibility of the various gum base components.

Fillers/texturizers typically are inorganic, water-insoluble powders such as magnesium and calcium carbonate, ground limestone, silicate types such as magnesium and aluminum silicate, clay, alumina, talc, titanium oxide, mono-, di- and tri-calcium phosphate and calcium sulfate. Insoluble organic fillers including cellulose polymers such as wood as well as combinations of any of these also may be used.

Selection of various components in chewing gum bases or chewing gum formulations of this invention typically are dictated by factors, including for example the desired properties (e.g., physical (mouthfeel), taste, odor, and the like) and/or applicable regulatory requirements (e.g., in order to have a food grade product, food grade components, such as food grade approved oils like vegetable oil, may be used.)

Colorants and whiteners may include FD&C-type dyes and lakes, fruit and vegetable extracts, titanium dioxide, and combinations thereof.

Antioxidants such as BHA, BHT, tocopherols, propyl gallate and other food acceptable antioxidants may be employed to prevent oxidation of fats, oils and elastomers in the gum base.

As noted, the base may include wax or be wax-free. An example of a wax-free gum base is disclosed in U.S. Pat. No. 5,286,500, the disclosure of which is incorporated herein by reference.

A water-insoluble gum base typically constitutes approximately 5 to about 95 percent, by weight, of a chewing gum of this invention; more commonly, the gum base comprises 10 to about 50 percent of a chewing gum of this invention; and in some preferred embodiments, 20 to about 35 percent, by weight, of such a chewing gum.

In addition to a water-insoluble gum base portion, a typical chewing gum composition includes a water-soluble bulk portion (or bulking agent) and one or more flavoring agents. The water-soluble portion can include high intensity sweeteners, binders, flavoring agents (which may be water insoluble), water-soluble softeners, gum emulsifiers, colorants, acidulants, fillers, antioxidants, and other components that provide desired attributes.

Water-soluble softeners, which may also known as water-soluble plasticizers and plasticizing agents, generally constitute between approximately 0.5 to about 15% by weight of the chewing gum. Water-soluble softeners may include glycerin, lecithin, and combinations thereof. Aqueous sweetener solutions such as those containing sorbitol, hydrogenated starch hydrolysates (HSH), corn syrup and combinations thereof, may also be used as softeners and binding agents (binders) in chewing gum.

Preferably, a bulking agent or bulk sweetener will be useful in chewing gums of this invention to provide sweetness, bulk and texture to the product. Typical bulking agents include sugars, sugar alcohols, and combinations thereof. Bulking agents typically constitute from about 5 to about 95% by weight of the chewing gum, more typically from about 20 to about 80% by weight and, still more typically, from about 30 to about 70% by weight of the gum. Sugar bulking agents generally include saccharide containing components commonly known in the chewing gum art, including, but not limited to, sucrose, dextrose, maltose, dextrin, dried invert sugar, fructose, levulose, galactose, corn syrup solids, and the like, alone or in combination. In sugarless gums, sugar alcohols such as sorbitol, maltitol, erythritol, isomalt, mannitol, xylitol and combinations thereof are substituted for sugar bulking agents. Combinations of sugar and sugarless bulking agents may also be used.

In addition to the above bulk sweeteners, chewing gums typically comprise a binder/softener in the form of a syrup or high-solids solution of sugars and/or sugar alcohols. In the case of sugar gums; corn syrups and other dextrose syrups (which contain dextrose and significant amounts higher saccharides) are most commonly employed. These include syrups of various DE levels including high-maltose syrups and high fructose syrups. In the case of sugarless products, solutions of sugar alcohols including sorbitol solutions and hydrogenated starch hydrolysate syrups are commonly used. Also useful are syrups such as those disclosed in U.S. Pat. No. 5,651,936 and US 2004-234648 which are incorporated herein by reference. Such syrups serve to soften the initial chew of the product, reduce crumbliness and brittleness and increase flexibility in stick and tab products. They may also control moisture gain or loss and provide a degree of sweetness depending on the particular syrup employed. In the case of syrups and other aqueous solutions, it is generally desirable to use the minimum practical level of water in the solution to the minimum necessary to keep the solution free-flowing at acceptable handling temperatures. The usage level of such syrups and solutions should be adjusted to limit total moisture in the gum to less than 3 wt. %, preferably less than 2 wt. % and most preferably less than 1 wt. %.

High-intensity artificial sweeteners can also be used in combination with the above-described sweeteners. Preferred sweeteners include, but are not limited to sucralose, aspartame, salts of acesulfame, alitame, neotame, saccharin and its salts, cyclamic acid and its salts, glycyrrhizin, stevia and stevia compounds such as rebaudioside A, dihydrochalcones, thaumatin, monellin, lo han guo and the like, alone or in combination. In order to provide longer lasting sweetness and flavor perception, it may be desirable to encapsulate or otherwise control the release of at least a portion of the artificial sweetener. Such techniques as wet granulation, wax granulation, spray drying, spray chilling, fluid bed coating, coacervation, and fiber extrusion may be used to achieve the desired release characteristics.

Usage level of the artificial sweetener will vary greatly and will depend on such factors as potency of the sweetener, rate of release, desired sweetness of the product, level and type of flavor used and cost considerations. Thus, the active level of artificial sweetener may vary from 0.02 to about 8% by weight. When carriers used for encapsulation are included, the usage level of the encapsulated sweetener will be proportionately higher.

Combinations of sugar and/or sugarless sweeteners may be used in chewing gum. Additionally, the softener may also provide additional sweetness such as with aqueous sugar or alditol solutions.

If a low calorie gum is desired, a low caloric bulking agent can be used. Examples of low caloric bulking agents include: polydextrose; Raftilose, Raftilin; fructooligosaccharides (NutraFlora); Palatinose oligosaccharide; Guar Gum Hydrolysate (Sun Fiber); or indigestible dextrin (Fibersol). However, other low calorie bulking agents can be used. In addition, the caloric content of a chewing gum can be reduced by increasing the relative level of gum base while reducing the level of caloric sweeteners in the product. This can be done with or without an accompanying decrease in piece weight.

A variety of flavoring agents can be used. The flavor can be used in amounts of approximately 0.1 to about 15 weight percent of the gum, and preferably, about 0.2 to about 5%. Flavoring agents may include essential oils, synthetic flavors or mixtures thereof including, but not limited to, oils derived from plants and fruits such as citrus oils, fruit essences, peppermint oil, spearmint oil, other mint oils, clove oil, oil of wintergreen, anise and the like. Artificial flavoring agents and components may also be used. Natural and artificial flavoring agents may be combined in any sensorially acceptable fashion. Sensate components which impart a perceived tingling or thermal response while chewing, such as a cooling or heating effect, also may be included. Such components include cyclic and acyclic carboxamides, menthol derivatives, and capsaicin among others. Acidulants may be included to impart tartness.

In addition to typical chewing gum components, chewing gums of the present invention may include active agents such as dental health actives such as minerals, nutritional supplements such as vitamins, health promoting actives such as antioxidants for example resveratrol, stimulants such as caffeine, medicinal compounds and other such additives. These active agents may be added neat to the gum mass or encapsulated using known means to prolong release and/or prevent degradation. The actives may be added to coatings, rolling compounds and liquid or powder fillings where such are present.

It may be desirable to add components to the gum or gum base composition which enhance environmental degradation of the chewed cud after it is chewed and discarded. For example, in the case of a polyester elastomer, an esterase enzyme may be added to accelerate decomposition of the polymer. Alternatively, proteinases such as proteinase K, pronase, and bromelain can be used to degrade poly(lactic acid) and cutinases may be used to degrade poly(6-methyl-ε-caprolactone). Such enzymes may be available from Valley Research, Novozymes, and other suppliers. Optionally, the enzyme or other degradation agent may be encapsulated by spray drying, fluid bed encapsulation or other means to delay the release and prevent premature degradation of the cud. The degradation agent (whether encapsulated or not) may be used in compositions employing tri-block copolymers and tri-block elastomer systems as well as the multi-component systems previously described to further reduce the problems associated with improperly discarded gum cuds.

The present invention may be used with a variety of processes for manufacturing chewing gum including batch mixing, continuous mixing and tableted gum processes.

Chewing gum bases of the present invention may be easily prepared by combining the tri-block copolymer with a suitable plasticizer as previously disclosed. If additional ingredients such as softeners, plastic resins, emulsifiers, fillers, colors and antioxidants are desired, they may be added by conventional batch mixing processes or continuous mixing processes. Process temperatures are generally from about 60° C. to about 130° C. in the case of a batch process. If it is desired to combine the plasticized tri-block copolymer with conventional elastomers, it is preferred that the conventional elastomers be formulated into a conventional gum base before combining with the tri-block copolymer gum base. To produce the conventional gum base, the elastomers are first ground or shredded along with filler. Then the ground elastomer is transferred to a batch mixer for compounding. Essentially any standard, commercially available mixer known in the art (e.g., a Sigma blade mixer) may be used for this purpose. The first step of the mixing process is called compounding. Compounding involves combining the ground elastomer with filler and elastomer plasticizer (elastomer solvent). This compounding step generally requires long mixing times (30 to 70 minutes) to produce a homogeneous mixture. After compounding, additional filler and elastomer plasticizer are added followed by PVAc and finally softeners while mixing to homogeneity after each added ingredient. Minor ingredients such as antioxidants and color may be added at any time in the process. The conventional base is then blended with the tri-block copolymer base in the desired ratio. Whether the tri-block copolymer is used alone or in combination with conventional elastomers, the completed base is then extruded or cast into any desirable shape (e.g., pellets, sheets or slabs) and allowed to cool and solidify.

Alternatively, continuous processes using mixing extruders, which are generally known in the art, may be used to prepare the gum base. In a typical continuous mixing process, initial ingredients (including ground elastomer, if used) are metered continuously into extruder ports various points along the length of the extruder corresponding to the batch processing sequence. After the initial ingredients have massed homogeneously and have been sufficiently compounded, the balance of the base ingredients are metered into ports or injected at various points along the length of the extruder. Typically, any remainder of elastomer component or other components are added after the initial compounding stage. The composition is then further processed to produce a homogeneous mass before discharging from the extruder outlet. Typically, the transit time through the extruder will be substantially less than an hour. If the gum base is prepared from tri-block copolymer without conventional elastomers, it may be possible to reduce the necessary length of the extruder needed to produce a homogeneous gum base with a corresponding reduction in transit time. In addition, the tri-block copolymer need not be pre-ground before addition to the extruder. It is only necessary to ensure that the tri-block copolymer is reasonably free-flowing to allow controlled, metered feeding into the extruder inlet port.

Exemplary methods of extrusion, which may optionally be used in conjunction with the present invention, include the following, the entire contents of each being incorporated herein by reference: (i) U.S. Pat. No. 6,238,710, claims a method for continuous chewing gum base manufacturing, which entails compounding all ingredients in a single extruder; (ii) U.S. Pat. No. 6,086,925 discloses the manufacture of chewing gum base by adding a hard elastomer, a filler and a lubricating agent to a continuous mixer; (iii) U.S. Pat. No. 5,419,919 discloses continuous gum base manufacture using a paddle mixer by selectively feeding different ingredients at different locations on the mixer; and, (iv) yet another U.S. Pat. No. 5,397,580 discloses continuous gum base manufacture wherein two continuous mixers are arranged in series and the blend from the first continuous mixer is continuously added to the second extruder.

Chewing gum is generally manufactured by sequentially adding the various chewing gum ingredients to commercially available mixers known in the art. After the ingredients have been thoroughly mixed, the chewing gum mass is discharged from the mixer and shaped into the desired form, such as by rolling into sheets and cutting into sticks, tabs or pellets or by extruding and cutting into chunks.

Generally, the ingredients are mixed by first softening or melting the gum base and adding it to the running mixer. The gum base may alternatively be softened or melted in the mixer. Color and emulsifiers may be added at this time.

A chewing gum softener such as glycerin can be added next along with part of the bulk portion. Further parts of the bulk portion may then be added to the mixer. Flavoring agents are typically added with the final part of the bulk portion. The entire mixing process typically takes from about five to about fifteen minutes, although longer mixing times are sometimes required.

In yet another alternative, it may be possible to prepare the gum base and chewing gum in a single high-efficiency extruder as disclosed in U.S. Pat. No. 5,543,160. Chewing gums of the present invention may be prepared by a continuous process comprising the steps of: a) adding gum base ingredients into a high efficiency continuous mixer; b) mixing the ingredients to produce a homogeneous gum base, c) adding at least one sweetener and at least one flavor into the continuous mixer, and mixing the sweetener and flavor with the remaining ingredients to form a chewing gum product; and d) discharging the mixed chewing gum mass from the single high efficiency continuous mixer. In the present invention, it may be necessary to first blend the tri-block copolymer with a suitable plasticizer before incorporation of additional gum base or chewing gum ingredients. This blending and compression process may occur inside the high-efficiency extruder or may be performed externally prior to addition of the plasticized tri-block copolymer composition to the extruder.

Of course, many variations on the basic gum base and chewing gum mixing processes are possible.

After mixing, the chewing gum mass may be formed, for example by rolling or extruding into and desired shape such as sticks, tabs, chunks or pellets. The product may also be filled (for example with a liquid syrup or a powder) and/or coated for example with a hard sugar or polyol coating using known methods.

After forming, and optionally filling and/or coating, the product will typically be packaged in appropriate packaging materials. The purpose of the packaging is to keep the product clean, protect it from environmental elements such as oxygen, moisture and light and to facilitate branding and retail marketing of the product.

### EXAMPLES

The following examples of the invention and comparative formulations are provided to illustrate, but not to limit, the invention which is defined by the attached claims. Amounts listed are in weight percent.

### Examples/Comparative Runs 1-12

Symmetric triblock copolymers were prepared from the ring-opening polymerization of D,L-lactide using α,ω-telechelic hydroxy terminated HO-P(6-MCL)-OH macroinitiators. Samples were prepared according to the present invention (Examples 1-10) as well as two Comparative Runs (11 and 12) which had midblocks which constituted less than 30% by weight of the polymer. Reactions were carried out in toluene using tin(II) octoate as the catalyst under a nitrogen environment at 110° C. for 2 hours. PLA weight fractions were targeted by mass. Crude products were precipitated in methanol to afford the PLA-P(6-MCL)-PLA products. Twelve PLA-P(6-MCL)-PLA triblocks were synthesized and are listed in Table 1. PLA-P(6-MCL)-PLA triblocks were characterized by ¹H NMR spectroscopy, size exclusion chromatography (SEC), differential scanning calorimetry (DSC).

TABLE 1

| | | | PLA | | | | | |
|---|---|---|---|---|---|---|---|---|
| | PLA-6MCL- | P(6-MCL | Mₙ | Mₙ | | | T_{g} | |
| | PLA | Mₙ NMR | NMR | SEC | | | PLA | |
| Ex./CR | MW (approx) | (kg/mol) | (kg/mol) | (kg/mol) | w_{PLA} | f_{PLA} | (K) | PDI |
| Ex. 1 | (7-12-7) | 11.6 | 14.0 | 43.7 | 0.55 | 0.49 | 312 | 1.11 |
| Ex. 2 | (9.6-16-9.6) | 15.8 | 19.1 | 49.2 | 0.55 | 0.49 | 316 | 1.17 |
| Ex. 3 | (13-20-13) | 19.8 | 26.9 | 71.3 | 0.58 | 0.51 | 315 | 1.19 |
| Ex. 4 | (26-38-26) | 38.0 | 52.0 | 110 | 0.58 | 0.52 | 323 | 1.18 |
| Ex. 5 | (42-61-42) | 60.0 | 82.9 | 140 | 0.58 | 0.52 | 326 | 1.24 |
| Ex. 6 | (2.5-20-2.5) | 21.6 | 4.9 | 55.9 | 0.18 | 0.15 | 281 | 1.15 |
| Ex. 7 | (3.6-20-3.6) | 21.2 | 7.2 | 57.4 | 0.25 | 0.21 | 290 | 1.18 |
| Ex. 8 | (4.6-20-4.6) | 20.9 | 9.2 | 58.1 | 0.31 | 0.26 | 302 | 1.18 |
| Ex. 9 | (6.7-20-6.7) | 21.2 | 13.4 | 62.6 | 0.39 | 0.33 | 309 | 1.16 |
| Ex. 10 | (20-20-20) | 17.9 | 39.3 | 95.2 | 0.69 | 0.63 | 306 | 1.40 |
| CR 11 | (30-20-30) | 18.9 | 60.8 | 129 | 0.76 | 0.72 | 321 | 1.35 |
| CR 12 | (41-20-41) | 18.3 | 82.0 | 142 | 0.82 | 0.78 | 321 | 1.49 |

The polymer of Example 2 was prepared according to the following procedure. (The other examples were prepared similarly by adjusting proportions of the reagents. Diblock copolymers of PLA-6MCL can be similarly synthesized by substituting a monofunctional alcohol such as benzyl alcohol for the difunctional alcohol, benzene dimethanol and adjusting reaction conditions according to desired specifications.)

In a one step Baeyer-Villiger oxidation reaction 6-methyl-ε-caprolactone (6-MCL) was produced from commercially available 2-methylcyclohexanone (Sigma Aldrich) using 3-chloroperoxybenzoic acid (m-CPBA, Sigma Aldrich, 70%) as the oxidant. The product was purified by reduced pressure fractional distillation and obtained in good yield (82%). In an addition funnel m-CPBA (110 g, 0.45 mol) was dissolved in dichloromethane (1 L). A 2 L round bottom flask equipped with magnetic stir bar was charged with 2-methylcyclohexanone (56.91 g, 0.507 mol). The flask was stirred and cooled in an icebath. The m-CPBA solution was added dropwise over 1 hour to the reaction solution, and was allowed to warm up to room temperature as the ice melted. The reaction solution was stirred overnight. Celite was added to the reaction solution as a filtration aid. The reaction solution was vacuum filtered through a celite plug retained by a porous glass frit. The solution was concentrated to −500 mL, and washed with aqueous solutions of sodium bisulfite, sodium bicarbonate, and brine. The organic was then dried with anhydrous magnesium sulfate and gravity filtered through filter paper to remove the magnesium sulfate. The remaining solvent was removed under reduced pressure. The product was purified by fractional distillation under reduced pressure over magnesium sulfate. The distilled product was a clear colorless liquid. After purification 47.4 g of product were obtained for a 82% yield. Activated 3 Å molecular sieves were added to the purified product to remove any trace water. ¹H NMR analysis of the purified product revealed two methyl substituted lactone regioisomers consistent with the established selectivity rules of the Baeyer-Villiger reaction. The two observed lactone products results from the oxygen insertion reaction taking place on either side of the carbonyl giving 6-methyl-ε-caprolactone (6-MCL) and 2-methyl-ε-caprolactone (2-MCL). 2-MCL impurity constituted approximately 5% of the total product and was removed prior to polymerization.

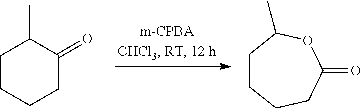

To enable synthesis of higher molecular weight polymers, it is desirable to purify the 6-MCL monomer to remove the aforementioned 2-MCL as well as trace hydrolysis or other chain transfer byproducts. This can be accomplished, for example, by the steps of filtration, extraction with CH₂CL₂ or ethyl acetate, drying over MgSO₄ and CaH₂, concentration under vacuum and then passing the monomer through an alumina column.

Poly(6-methyl-ε-caprolactone) (P(6-MCL)) was prepared from the controlled ring-opening polymerization (ROP) of 6-MCL catalyzed by tin(II) octoate (Sn(oct)₂) in the presence of 1,4-benzenedimethanol (BDM). The polymer products were characterized by NMR spectroscopy and size exclusion chromatography.

In the glovebox Sn(oct)₂ (0.0398 g, 98 μmol), BDM (0.0412 g, 0.30 mmol.), and 6-MCL (5 g, 39.1 mmol.) were added to a 15 mL pressure vessel equipped with a Teflon coated magnetic stirbar. The sealed reaction vessel was placed in a 110° C. oil bath and stirred for 8 hours. The cooled reaction solution was diluted with ˜10 mL tetrahydrofuran and precipitated into hexanes. The solvent was removed under reduced pressure at room temperature for 3 days.

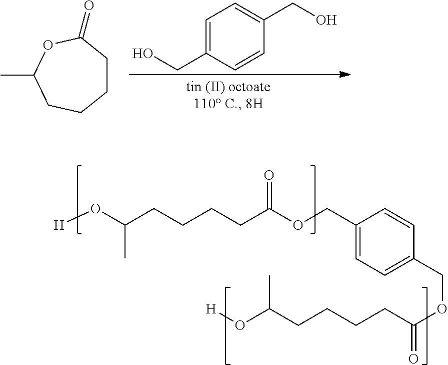

In the glovebox HO-P(6-MCL)-OH (0.87 g), Sn(oct)₂ (0.005 g, 13 μmol), D,L-lactide (1.06 g), and toluene (5 g) were added to a 15 mL pressure vessel equipped with a Teflon coated magnetic stir bar. The sealed reaction vessel was placed in a 110° C. oil bath and stirred for 2 hours. The reaction solution was cooled to room temperature and precipitated in methanol (Sigma Aldrich). The solvent was removed under reduced pressure at room temperature for 3 days.

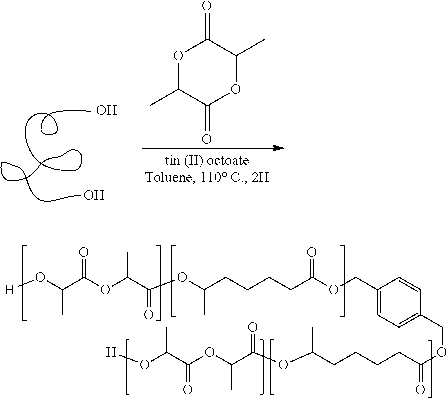

Monomer conversion was calculated using the integral ratio of the methane protons from the monomer (δ 5.05 ppm) and lactide repeat unit (δ 5.18 ppm). Monomer conversion was found to be greater than 95% complete for the polymers studied.

Rheological and thermal properties of these elastomers are shown in FIGS. 2 and 3, respectively. FIG. 2 shows the complex modulus of various PLA-P(6-MCL)-PLA block copolymers at 37° C. as a function of angular frequency. Specifically, this figure shows the effect of PLA weight fraction on complex modulus in a series of PLA-P(6-MCL)-PLA block copolymers which is useful because it allows for tuning of the PLA-P(6-MCL)-PLA system to exhibit conventional gum base rheology. More specifically, the complex modulus is shown for tri-block copolymers which comprise 18, 25, 30 and 58% end-block polymer by weight of the complete tri-block copolymer. Such data is particularly useful because it is known to accurately gauge the chewing properties of gum cuds and can therefore be used to discriminate between varying block copolymer compositions when choosing systems for gum production. Complex modulus in a range of 10⁴-10⁶ Pa at 10 rad/sec is typically associated with acceptable chew characteristics. FIG. 3 shows DSC thermographs of the elastomers shown in Examples 3, 6, 7, 8, and 9 and Comparative Runs 11 and 12. Two inflection points are noticeable with the first being at about −40° C. which is the T_{g} of the P(6-MCL) mid-block and the second at about 40° C. which is the T_{g} of the PLA end-blocks. These inflection points indicate that the neat PLA-P(6-MCL)-PLA block copolymer material has an internal, likely physically cross-linked, phase segregated microstructure before gum processing.

The gum formulas shown in Table 2 were prepared by mixing the ingredients in a sigma blade mixer.

TABLE 2

| | Example 13 | Example 14 | Example 15 |
|---|---|---|---|
| Ingredient | Comparative | Inventive | Inventive |
| Tri-Block Copolymer of | — | 33.0 | 20.1 |
| Example 9 | | | |
| Conventional Gum Base | 33.0 | — | — |
| Sorbitol | 46.4 | 46.4 | 67.6 |
| Calcium carbonate | 13.0 | 13.0 | 7.9 |
| Glycerin | 4.0 | 4.0 | 2.4 |
| Peppermint Flavor | 2.3 | 2.3 | 1.2 |
| Lecithin | 0.5 | 0.5 | 0.3 |
| Encapsulated and free | 0.8 | 0.8 | 0.5 |
| high-intensity | | | |
| sweeteners | | | |
| Total | 100.0 | 100.0 | 100.0 |

The inventive products mixed acceptably but were dry. The three chewing gums were kneaded by hand under water for 20 minutes to simulate chewing. This kneading was successful in forming cuds from the gum bases which were subsequently adhered to a paving stone. In the case of the Inventive Examples, the adhered cuds exhibited less spreading than the conventional gum cud and were easily removed using a scraper and the method previously described.

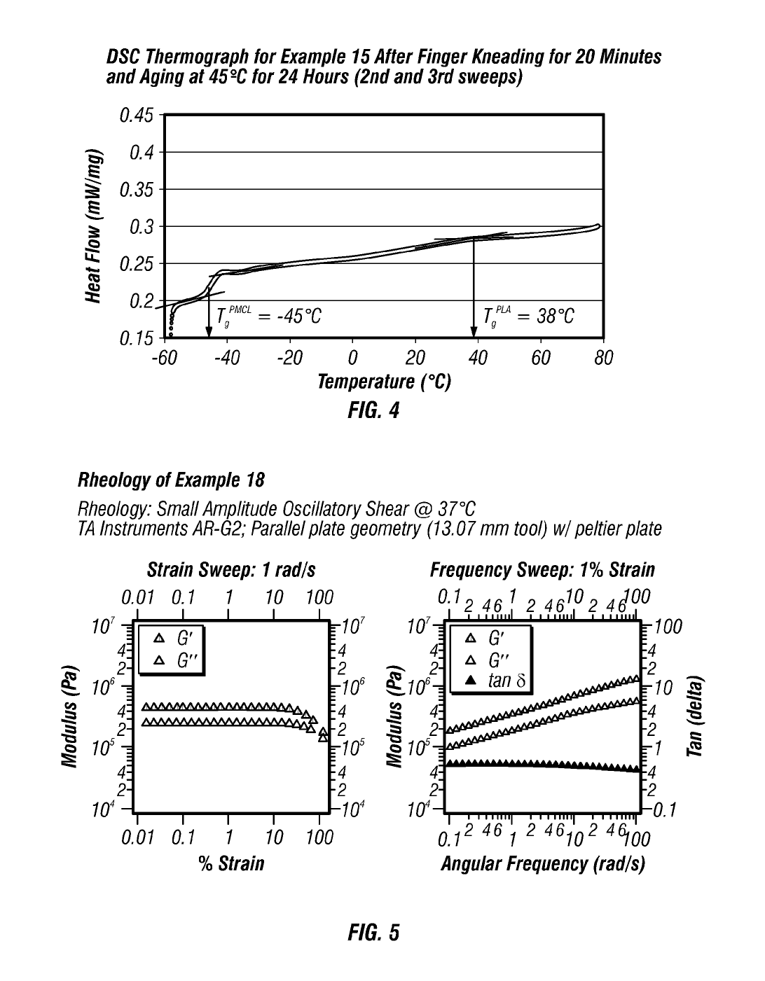

A sample of the chewing gum of Example 15 was kneaded under water for 20 minutes and then aged at 45° C. for 24 hours. A DSC thermograph of the aged sample is shown as FIG. 4. The thermograph shows two glass transitions which confirms the retention of the type of internal structure illustrated in FIG. 1. This phase morphology is believed to be responsible for the improved removability of this formulation.

### Example 16

Poly(DL-lactide-b-1,4-isoprene-b-DL-lactide) (LIL) was synthesized by anionic polymerization followed by anionic coordination polymerization. This polymerization requires a functionalized initiator which is not commercially available for synthesis of α,ω-dihydroxyl poly(1,4-isoprene), and its synthesis method is described below.

The synthesis of the protective initiator for LIL triblock copolymer, 3-triisopropylsilyloxy-1-propyllithium (TIPSOPrLi) followed the procedure published in 2007 by Meuler et al. All reagents without any specific description of purification processes were used as received. Cyclohexane (Fisher) and toluene (Mallinckrodt) were purified by passing through activated alumina columns.

Equivalent mole of imidazole (Sigma) to triisopropylchlorosilane (TIPS-Cl, Gelest) was added to a round bottom flask, evacuated and purged with dry argon five times, and dissolved in 5 ml of dimethylformamide (DMF) per 1 g of imidazole. The desired amount of TIPS-Cl was injected in the flask, and the solution was stirred until a clear and colorless solution is obtained. A molar excess of 3-chloro-1-propanol (Aldrich) was injected, and the solution was stirred for 24 hours under positive argon pressure. The reaction solution was diluted with 6 times as much diethyl ether as DMF by volume, washed with distilled water 3 times, and concentrated by rotary evaporator. The product, 3-triisopropylsilyloxy-1-propylchloride (TIPSOPrCl) was purified and collected by vacuum distillation (75° C. at 185 mTorr).

The lithiation of TIPSOPrCl was carried out under dry argon atmosphere. In a dry 1 L three port round-bottom flask with condenser and pressure equalizing additional funnel, a Teflon coated stir bar and lithium wire (Aldrich, 12.5 g, 1.8 mol) was added and washed with dry cyclohexane by cannula transfer technique. Fresh cyclohexane (˜300 ml) was charged in the reactor, and the lithium and cyclohexane solution was vigorously stirred overnight to activate lithium surface by mechanical abrasion. The second cyclohexane was removed, and fresh cyclohexane (˜500 ml) was charged in the reactor. TIPSOPrCl (34.45 g, 0.139 mol) was injected to the additional funnel and added slowly to the lithium solution for 2.5 hours. While the TIPSOPrCl was added, the lithium solution was vigorously stirring in an oil bath at 40° C. The slow addition of TIPSOPrCl is very important since the lithiation reaction is highly exothermic and the start of lithiation reaction cannot be controlled. However, it can be detected by temperature increase of the oil bath, and each addition of TIPSOPrCl should be carried out after the lithiation reaction by previous TIPSOPrCl addition is finished. The completion of lithiation of each addition of TIPSOPrCl can be confirmed by decrease of the oil bath temperature after steep increase of the temperature. After all the TIPSOPrCl was added, the reaction solution was vigorously stirred at 60° C. for 27 hours. The completion of the reaction was confirmed by No-D NMR technique. The reaction solution was filtered through a pad of Celite, and a faint yellowish TIPSOPrLi (0.17 M) in cyclohexane was obtained.

Synthesis of poly(DL-lactide-b-1,4-isopene-b-DL-lactide) was carried out under dry argon atmosphere. Isoprene (Acros) was vacuum transferred from n-butyllithium (Aldrich) twice at 0° C. for purification. Ethylene oxide (Aldrich) was purified with butylmagnesium chloride (Aldrich) at 0° C. twice and vacuum distilled. DL-Lactide (Purac) was re-crystallized in toluene, dried under dynamic vacuum for 24 hours, and stored in a dry box.

Synthesis of α-triisopropylsilyloxypropyl-ω-hydroxyl poly(1,4-isoprene): α-triisopropylsilyloxypropyl-ω-hydroxyl poly(1,4-isoprene) (TIPSO-PI-OH) was carried out under positive argon pressure at 40° C. Cyclohexane (4 L) was charged in a dry glass reactor. TIPSOPrLi (25.4 mL of 1.6 M, 3.92 mmol) was injected to the reactor with a gas-tight syringe and vigorously stirred for 1 hour. Isoprene (311 g, 4.57 mol) was added to the reactor slowly for 6 hours and stirred for 12 hours. Slow addition of isoprene is very important to prevent thermal vulcanization of polyisoprene or reactor explosion since the polymerization reaction is highly exothermic. Ethylene oxide (13 g, 0.295 mol) was added to the reactor and stirred for another 12 hours for hydroxyl end-capping. Polymerization was terminated with excess argon-purged methanol (Sigma), and residual ethylene oxide was vented for 3 hours. Synthesized TIPSO-PI-OH was precipitated in methanol, dried under dynamic vacuum at room temperature for 24 hours, and stored at −20° C. Based on nuclear magnetic resonance spectrum, the amount of isoprene monomer residue in PI-OH was not detectable (detection limit: 20 ppm).

Deprotection of triisopropylsilyl protective group: TIPS-O-PI-OH was dissolved in tetrahydrofuran (Sigma), deprotected with 20 molar excess of tetra(n-butyl)ammonium fluoride in water (Aldrich) to the mole of TIPS group for 48 hours at room temperature, and precipitated in methanol repeatedly until no triisopropylsilane group is detected on nuclear magnetic resonance (NMR) spectrum. Typically two times precipitation was necessary. The deprotected α,ω-dihydroxyl poly(1,4-isopene) (HO-PI-OH) was dried under dynamic vacuum for 24 hours and stored at −20° C.

Synthesis of poly(DL-lactide-b-1,4-isoprene-b-DL-lactide): Poly(DL-lactide) block was polymerized in toluene under dry argon atmosphere at 90° C. Desired amount of HO-PI-OH was dissolved in toluene in a round bottom flask reactor, and dried under dynamic vacuum to remove water at room temperature for 24 hours. The dry HO-PI-OH was re-dissolved in desired amount of dry toluene to make approximately 5 mM concentration of hydroxyl functions, and one third mole of triethylaluminum (Sigma) to the number of the hydroxyl groups was added to the reactor in a dry box. The reactor was removed from the dry box and stirred for 6 hours in an oil bath at 90° C. Desired amount of DL-lactide was added to the reactor in a dry box to the reactor, and the reactor was stirred for 24 hours in an oil bath at 90° C. The polymerization was terminated with an excess mixture of water and tetrahydrofuran. LIL triblock copolymer was recovered by precipitation in methanol and dried under vacuum for 24 hours. Yields of polymerization were approximately 85%. Based on a size exclusion chromatography, residual DL-lactide monomer in LIL block copolymers were not detectable (detection limit: 400 ppm).

The molecular weight of the three blocks (in kDa) was determined to be 7.6-74-7.6. A structural representation of the synthesis of poly(DL-lactide-b-1,4-isopene-b-DL-lactide) is shown below.

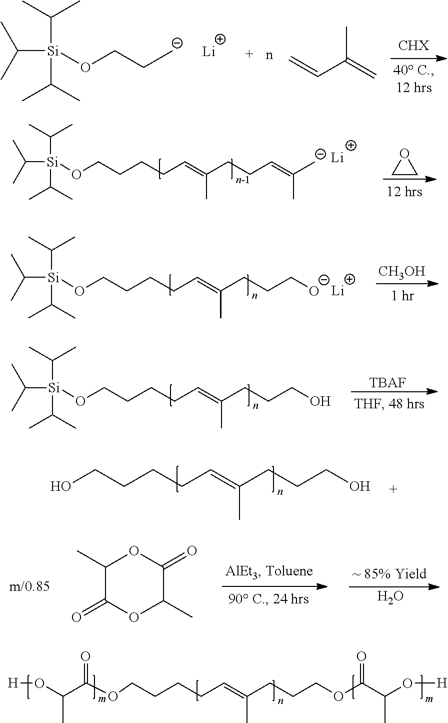

### Example 17

Poly(1,4-isoprene-b-DL-lactide) di-block copolymer which can be used as a plasticizer for the above PLA-polyisoprene-PLA triblock copolymer was synthesized as follows.

Poly(1,4-isoprene-b-DL-lactide) (IL) was synthesized by anionic polymerization followed by anionic coordination polymerization.

All polymerization reactions were carried out under dry argon atmosphere. Isoprene (Acros) was vacuum transferred from n-butyllithium (Aldrich) twice at 0° C. for purification. Ethylene oxide (Aldrich) was purified with butylmagnesium chloride (Aldrich) at 0° C. twice and vacuum distilled. DL-Lactide (Purac) was re-crystallized in toluene (Mallinckrodt), dried under dynamic vacuum for 24 hours, and stored in a dry box. Cyclohexane (Fisher) and toluene were purified by passing through activated alumina columns.

Synthesis of ω-hydroxyl poly(1,4-isoprene): polymerizations of ω-hydroxyl poly(1,4-isoprene) (PI-OH) was carried out under positive argon pressure at 40° C. Cyclohexane (2 L) was charged in a dry glass reactor. sec-Butyllithium (Aldrich, 2.8 mL of 1.4 M, 3.92 mmol) was injected to the reactor with a gas-tight syringe and vigorously stirred for 1 hour. Isoprene (107 g, 1.57 mol) was added to the reactor slowly for 3 hours and stirred for 12 hours. Slow addition of isoprene is very important to prevent thermal vulcanization or reactor explosion since the polymerization reaction is highly exothermic. Ethylene oxide (10 g, 227 mmol) was added to the reactor and stirred for another 12 hours for hydroxyl end-capping. Polymerization was terminated with excess argon-purged methanol (Sigma), and residual ethylene oxide was vented for 3 hours. Synthesized PI-OH was precipitated in methanol, dried under dynamic vacuum at room temperature for 24 hours, and stored at −20° C. Based on nuclear magnetic resonance spectrum, the amount of isoprene monomer residue in PI-OH was not detectable (detection limit: 20 ppm).

Synthesis of poly(1,4-isoprene-b-DL-lactide): Poly(DL-lactide) block was polymerized in toluene under argon atmosphere at 90° C. Desired amount of PI-OH was dissolved in toluene in a round bottom flask reactor, and dried under dynamic vacuum to remove water at room temperature for 24 hours. The dry PI-OH was re-dissolved in desired amount of dry toluene to make approximately 5 mM concentration of hydroxyl functions, and one third mole of triethylaluminum (Sigma) to the number of the hydroxyl groups was added to the reactor in a dry box. The reactor was removed from the dry box and stirred for 6 hours in an oil bath at 90° C. Desired amount of DL-lactide was added to the reactor in a dry box to the reactor, and the reactor was stirred for 24 hours in an oil bath at 90° C. The polymerization was terminated by an excess mixture of water and tetrahydrofuran. IL block copolymer was recovered by precipitation in methanol and dried under vacuum for 24 hours. Yields of polymerization were approximately 85%. Based on a size exclusion chromatography, residual DL-lactide monomer in IL block copolymers were not detectable (detection limit: 400 ppm).

The molecular weight of the isoprene and lactide blocks (in kDa) was determined to be 35 and 6.7 respectively. A structural representation of the synthesis of Poly(1,4-isoprene-b-DL-lactide) is shown below.

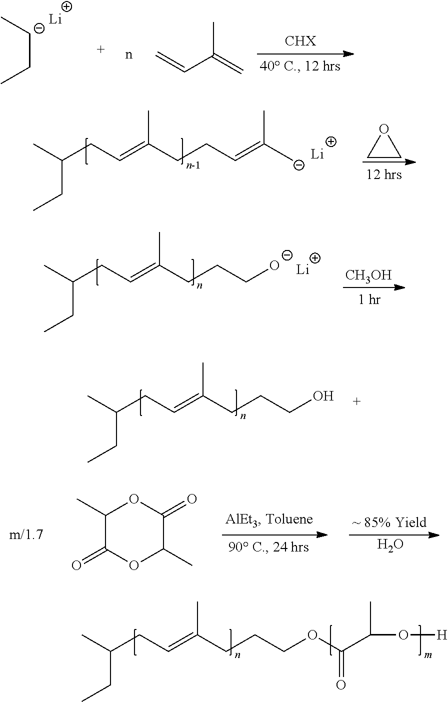

### Example 18

PLA-P(6-MCL)-PLA, was prepared by the following bulk polymerization method.

Glassware was baked in a 110° C. oven overnight prior to polymerization. All reagents were purified as previously described in Example 2.

In a glovebox 6-methyl-ε-caprolactone (193.46 g) was added to a 500 mL reaction kettle followed by 1,4-benzenedimethanol (1.3364 g) and Sn(oct)₂ (1.2226 g). The kettle was sealed and the ports stoppered, one port was equipped with at gas inlet port, before removing the reactor assembly from the glovebox. The reactor was pressurized with ˜2.5 psi of nitrogen. A blade-type overhead stirrer was added, under a flow of nitrogen, prior to immersion of the reactor into a heated oil bath. The temperature setpoint remained at 100° C. for 8 hours, then 110° C. for 9.3 hours. The reactor was then cooled in an icebath prior to adding D,L-lactide (131.92 g) under a stream of nitrogen. The reactor was returned to the oil bath and the setpoint changed to 140° C. After 2 hours the reactor was cooled to room temperature, diluted in 3 L of THF and precipitated in 16 L of methanol. To remove residual monomer the polymer was kneaded under 4 L of methanol, diluted in 3 L of THF and reprecipitated into cyclohexanes. Residual solvent was removed in a vacuum oven for 2 days.

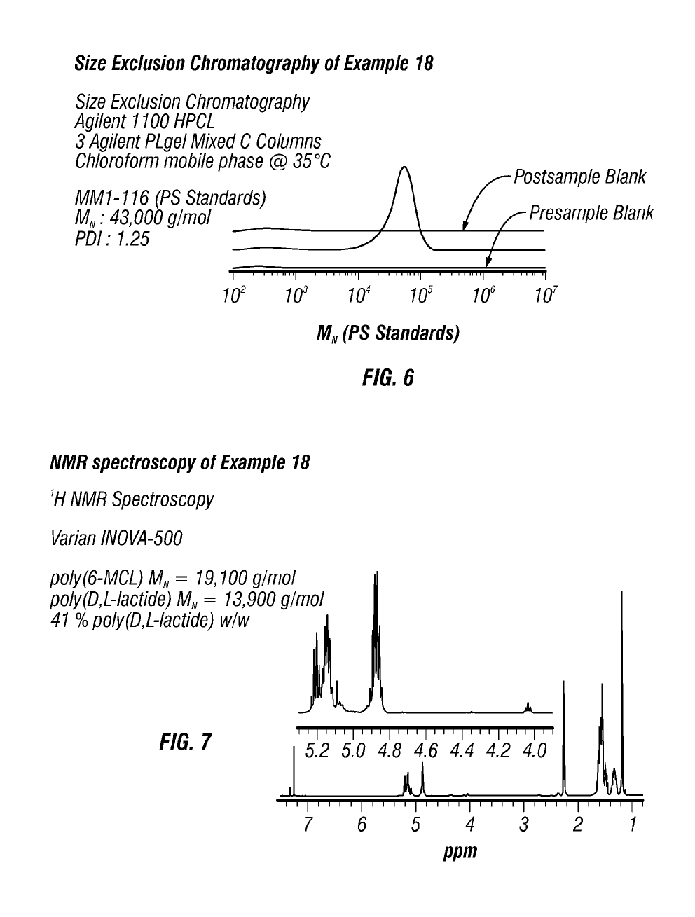

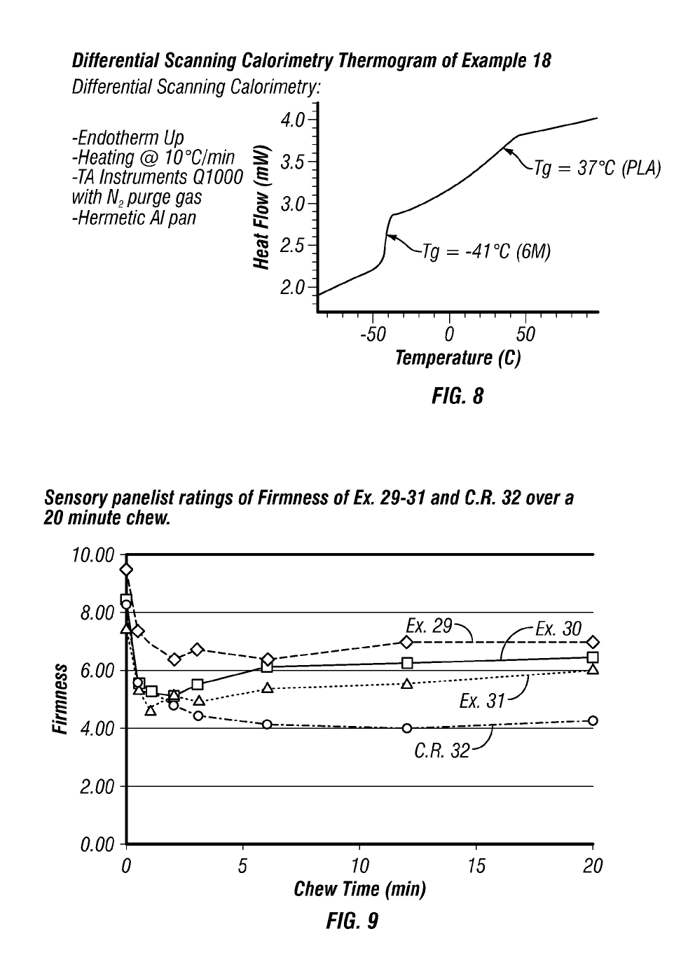

The product, poly(D,L-lactide-b-6-MCL-b-D,L-lactide) (7 kDa-19 kDa-7 kDa), was subjected to rheological testing (FIG. 5), size exclusion chromatography (FIG. 6), NMR spectroscopy (FIG. 7) and differential scanning calorimetry (FIG. 8) for characterization purposes.

### Example 19

Chewing gum was made using the polymer of Example 18 was made according to Table 3.

TABLE 3

| | Example 19 |
|---|---|
| Ingredient | % by weight |
| Gum Base Components | |
| Triblock copolymer of Ex. 18 | 85.38 |
| Microcrystalline Wax | 7.31 |
| Calcium Carbonate | 7.31 |
| Total gum Base | 100.00 |
| Chewing Gum Components | |
| Gum Base (from above) | 52.70 |
| Sorbitol | 31.70 |
| Glycerin (99%) | 8.50 |
| Peppermint Flavor | 6.35 |
| High-Intensity Sweetener | 0.75 |
| Total Gum | 100.00 |

### Examples 20-23

Chewing gums can be made according the formulas in Table 4 by first compounding the gum base ingredients, then mixing the base with the chewing gum components.

TABLE 4

| | Ex. 20 | Ex. 21 | Ex. 22 | Ex. 23 |
|---|---|---|---|---|
| Gum Base Components | | | | |
| Triblock copolymer of Ex. 18 | 11.00 | 4.00 | 21.00 | 18.00 |
| Butyl Rubber | 3.10 | 5.10 | — | — |
| Polyisobutylene (low MW) | 9.10 | 7.50 | 11.00 | — |
| Terpene Resin | 18.00 | 14.00 | 19.50 | 3.00 |
| Polyvinyl Acetate (low MW) | 15.00 | 13.00 | 25.50 | 30.00 |
| Lecithin | 2.00 | 1.50 | 3.00 | 2.50 |
| Calcium Carbonate | 16.80 | 30.90 | — | 28.50 |
| Microcrystalline Wax | 3.00 | 3.00 | 4.00 | — |
| Hydrogenated Vegetable Oil | 22.00 | 21.00 | 16.00 | 18.00 |
| Total Gum Base | 100.00 | 100.00 | 100.00 | 100.00 |
| Chewing Gum Components | | | | |
| Gum base (from above) | 35.00 | 38.00 | 30.00 | 40.00 |
| Sorbitol | 53.55 | 53.00 | 58.05 | 53.00 |
| Hydrogenated Starch Hydrolysate | 8.00 | 5.00 | 8.50 | — |
| Syrup (85% solids) | | | | |
| Peppermint flavor | 1.00 | 1.20 | 1.10 | 1.50 |
| Glycerin (99%) | 2.00 | 2.50 | 2.00 | 5.00 |
| Lecithin | 0.15 | 0.10 | 0.15 | — |
| Encapsulated sucralose | 0.30 | 0.20 | 0.20 | 0.50 |
| Total Gum | 100.00 | 100.00 | 100.00 | 100.00 |

### Comparative Run 24 and Examples 25 and 26

A blend of 60% of the triblock copolymer of Example 16 and 40% of the diblock copolymer of Example 17 was made to test the plasticized triblock polymer as a replacement for butyl rubber. Gum bases and chewing gums were made from the blend and from a commercial butyl rubber as a control according to Table 5.

TABLE 5

| | C.R. 24 | Ex. 25 | Ex. 26 |
|---|---|---|---|
| Ingredient | Comparative | Inventive | Inventive |
| Gum Base Components | | | |
| 60:40 Example 16:Example 17 | — | 10.00 | |
| LML Polymer of Ex. 18 | — | | 10.00 |
| Butyl Rubber | 10.00 | — | — |
| Terpene Resin | 25.00 | 25.00 | 25.00 |
| Polyvinyl Acetate (low MW) | 20.00 | 20.00 | 20.00 |
| Lecithin | 2.00 | 2.00 | 2.00 |
| Calcium Carbonate | 20.00 | 20.00 | 20.00 |
| Hydrogenated Vegetable Oil | 22.95 | 22.95 | 22.95 |
| BHA | 0.05 | 0.05 | 0.05 |
| Total Gum Base | 100.00 | 100.00 | 100.00 |
| Chewing Gum Components | | | |
| Gum base (from above) | 33.00 | 33.00 | 33.00 |
| Sorbitol | 57.00 | 57.00 | 57.00 |
| Maltitol | 2.00 | 2.00 | 2.00 |
| Peppermint flavor | 2.00 | 2.00 | 2.00 |
| Glycerin | 5.00 | 5.00 | 5.00 |
| Lecithin | 0.50 | 0.50 | 0.50 |
| High Intensity Sweetener | 0.50 | 0.50 | 0.50 |
| Total Gum | 100.00 | 100.00 | 100.00 |

The chewing gums of Comparative Run 24 and Examples 25 and 26 were informally evaluated for chewing texture. They were perceived as excessively soft but otherwise acceptable.

### Examples 27-31

6-Methyl-ε-caprolactone was prepared from 2-methylcyclohexanone (Aldrich) using Oxone® (DuPont) as a green oxidant. To a 10.0 mL roundbottom flask 2-methylcyclohexanone (0.721 g), methanol (20 mL), water (20 mL), and sodium bicarbonate (3 g) were added. The vessel was vigorously stirred with a Teflon coated magnetic stir bar. Oxone (4 g) was added in two portions with the second being added 10 min after the first. Vigorous bubbling was noted for the first 20 min of the reaction. The reaction was allowed to stir for 6 hours followed by filtration and extracted with methylene chloride. The organic phase was concentrated under vacuum. A total of 0.82 g was recovered for a quantitative yield. The monomer was purified by fractional vacuum distillation from calcium hydride and stored over 3 Å activated molecular sieves. Additional purification of 6-methyl-ε-caprolactone was needed to produce monomodal high molecular weight poly(6-MCL) by passing the distilled monomer through a column of activated basic alumina under nitrogen pressure. This procedure was scaled appropriately according to techniques known in the art in order to prepare sufficient monomer for synthesis of the di-block and tri-block copolymers of Examples 27.

A triblock copolymer of poly(D,L-lactide-b-6-MCL-b-D,L-lactide) having molecular weight of 33 kDa-98 kDa-33 kDa was prepared as follows. To a 350 mL pressure vessel 6-methyl-ε-Caprolactone (231.3 g, 1.8 mol), 1,4-benzenedimethanol (0.3283 g, 2.38 mmol), and Sn(Oct)₂ (0.92 g, 2.27 mmol) was added in a nitrogen filled glovebox. The vessel was sealed and taken out of the box. The reaction vessel was submersed in a temperature controlled oil bath at 130° C. for 8 h before allowing the reaction to cool to room temperature. The vessel was opened to air and the polymer was diluted in 1 L of chloroform. The polymer was precipitated in 12 L of cyclohexane. The supernatant was decanted and the residual solvent was removed under vacuum. To a 2 L round bottomed flask 500 mL of toluene and 70 g of the purified polymer were added in the glovebox. The vessel was sealed and heated to 105° C. until all of the polymer had dissolved. The vessel was cooled to room temperature before adding D,L-Lactide (477.6 g, 3.31 mol) and Sn(Oct)₂ (0.316 g, 10.5 mmol). The reaction vessel was reheated to 105° C. for 7 hours and then allowed to cool to room temperature. The polymer was precipitated in methanol. The supernatant was decanted and the residual solvent was removed under vacuum.

A diblock copolymer of poly(D,L-lactide-b-6-MCL) having molecular weight of 5.5 kDa-9 kDa was prepared as follows. To a DIT 4 CV Helicone mixer benzylalcohol (8.1 g), Sn(Oct)₂ (4.2 g), and 6-MCL (670 g) were loaded under a nitrogen environment. The DIT 4 CV Helicone mixer was pre-heated to 130° C. and purged for several hours under a stream of nitrogen prior to charging the reactor. The reaction mixture was allowed to stir for 8 hours at 130° C. During this time D,L-lactide (578 g) was preheated to a liquid at approximately 140 to 150° C. in a jacketed closed vessel under nitrogen. At exactly eight hours after the reactor was first charged the liquid D,L-lactide was transferred, under nitrogen, to the DIT 4 CV Helicone mixer. The reaction mixture was allowed to stir for 40 minutes at 130° C. prior to extrusion into a chilled teflon container. The teflon container was packed in dry-ice, and more dry-ice was added to the container after the reactor was emptied. The polymer was allowed to warm up to room temperature before being dissolved in THF and precipitated into MeOH. The polymer/solvent mixture formed a liquid-like layer at the bottom of the containers. The top layer was decanted off and a small amount of water was added until the polymer and solvent phase separated. The polymer was collected and the residual solvent was removed in a vacuum oven until constant mass.

The triblock and diblock copolymers were then blended in a 20:80 ratio (triblock:diblock). The plasticized triblock-diblock elastomer (designated Example 27) was used to make chewing gums according to the formulas in Table 6.

TABLE 6

| | Ex. 28 | Ex. 29 | Ex. 30 | Ex. 31 |
|---|---|---|---|---|
| Ingredient | Inventive | Inventive | Inventive | Inventive |
| Gum Base Components | | | | |
| LML/LM elastomer of | 88.88 | 71.10 | 71.10 | 79.99 |
| Ex. 27 | | | | |
| Polyvinyl Acetate (low MW) | — | 17.78 | — | — |
| Triacetin | 5.56 | 5.56 | 5.56 | 5.56 |
| Acetylated Mono- and Di- | 5.56 | 5.56 | 5.56 | 5.56 |
| Glycerides | | | | |
| Calcium Carbonate | — | — | 17.78 | — |
| Microcrystalline Wax | — | — | — | 8.89 |
| Total Gum Base | 100.00 | 100.00 | 100.00 | 100.00 |
| Chewing Gum Components | | | | |
| Gum base (from above) | 36.00 | 36.00 | 36.00 | 36.00 |
| Sorbitol | 56.30 | 56.30 | 56.30 | 56.30 |
| Peppermint flavor | 2.00 | 2.00 | 2.00 | 2.00 |
| Glycerin | 5.20 | 5.20 | 5.20 | 5.20 |
| High Intensity Sweetener | 0.50 | 0.50 | 0.50 | 0.50 |
| Total Gum | 100.00 | 100.00 | 100.00 | 100.00 |

### Comparative Run 32

A laboratory batch of British Extra® Peppermint gum (a commercial product) was prepared and is designated as Comparative Run 32.

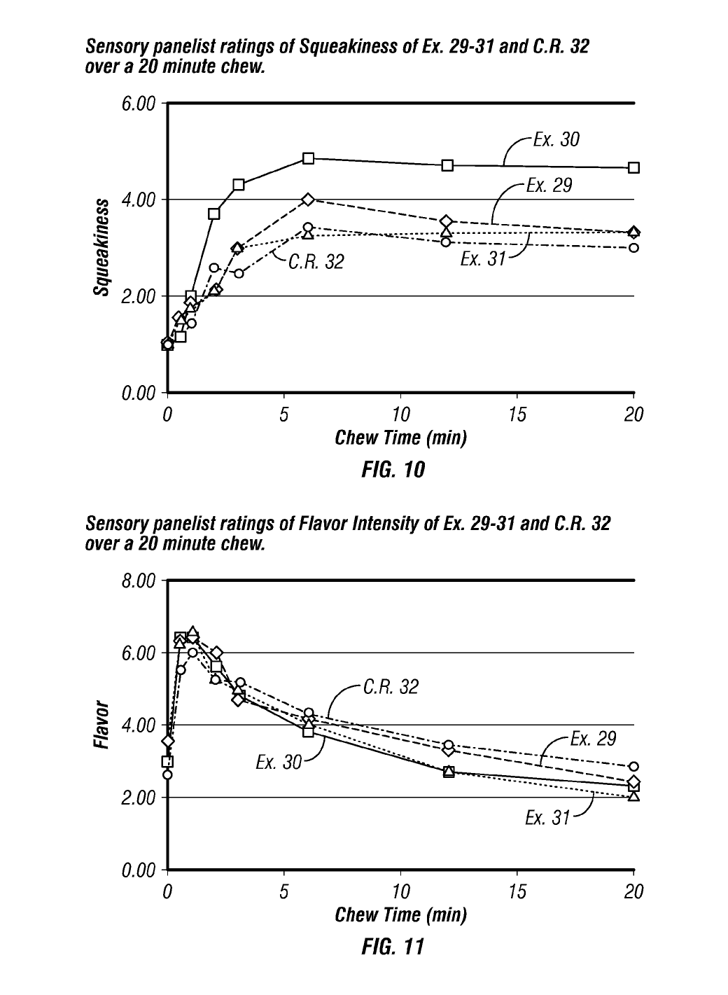

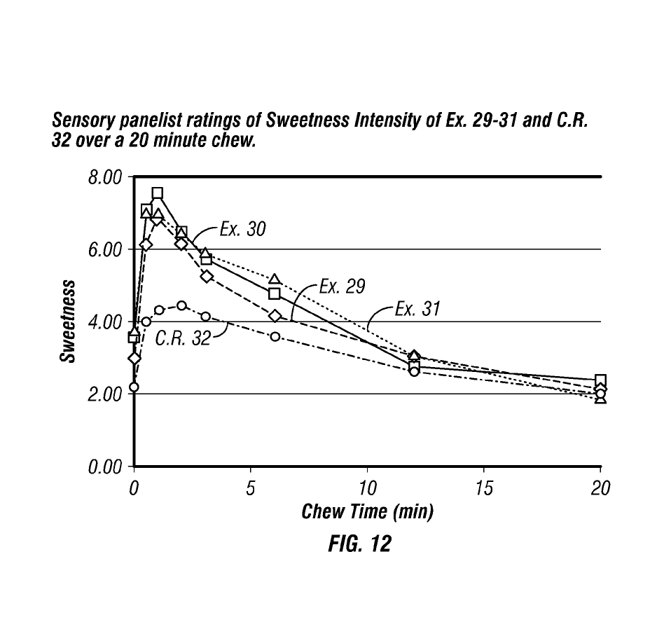

The chewing gums of Examples 29-31 and Comparative Run 32 were subjected to a formal sensory analysis by seven experienced panelists who rated the chewing gums for firmness, squeakiness, flavor intensity and sweetness intensity over a 20 minute chew. The results are shown in FIG. 9-12. The inventive examples showed excessive squeakiness and sweetness but were otherwise judged to be within the range of commercial chewing gums.

### Examples 33-40

A poly(D,L lactide)-Polyisoprene-poly(D,L lactide) tri-block copolymer (Ex. 33) and two corresponding di-block copolymers (Examples 34 and 35) were prepared. The tri-block copolymer was combined with the di-block copolymers in various combinations and ratios to produce plasticized tri-block copolymer elastomer systems. Details of the examples and their properties are presented in Table 7. Note that the blending of the tri-block and di-block copolymers allows for “tuning” of the elastomer system to any desired T_{g} within at least the range of 22° C. to 55° C.

TABLE 7

| | | | PLA | | | | | |
|---|---|---|---|---|---|---|---|---|
| | PLA-PI-PLA | PI Mₙ | Mₙ | Mₙ | | | T_{g} | |
| | or PI-PLA | NMR | NMR | NMR | | | PLA | |
| Ex. # | MW (kg/mol) | (kg/mol) | (kg/mol) | (kg/mol) | w_{PLA} | f_{PLA} | (° C.) | PDI |
| 33 | 17-62-17 | 62 | 33 | 95 | 0.35 | 0.28 | 55 | 1.08 |
| 34 | 4-1 | 4 | 1 | 5 | 0.22 | 0.17 | 10 | 1.08 |
| 35 | 4-3 | 4 | 3 | 7 | 0.42 | 0.34 | 39 | 1.16 |
| 36 | Ex. 33 (5 wt. %) | 7 | 5 | 12 | 0.34 | 0.28 | 42 | 1.55 |
| | Ex. 35 (95 wt. %) | | | | | | | |
| 37 | Ex. 33 (5 wt. %) | 7 | 4 | 10 | 0.39 | 0.32 | 26 | 1.55 |
| | Ex. 34 (24 wt. %) | | | | | | | |
| | Ex. 35 (71 wt. %) | | | | | | | |
| 38 | Ex. 33 (5 wt. %) | 7 | 4 | 11 | 0.37 | 0.30 | 23 | 1.62 |
| | Ex. 34 (47.5 wt. %) | | | | | | | |
| | Ex. 35 (47.5 wt. %) | | | | | | | |
| 39 | Ex. 33 (3 wt. %) | 6 | 4 | 10 | 0.34 | 0.28 | 41 | 1.43 |
| | Ex. 35 (97 wt. %) | | | | | | | |
| 40 | Ex. 33 (3 wt. %) | 6 | 3 | 9 | 0.37 | 0.31 | 22 | 1.40 |
| | Ex. 34 (48.5 wt. %) | | | | | | | |
| | Ex. 35 (48.5 wt. %) | | | | | | | |

### Examples 41-45

Lab scale chewing gum batches were made from the elastomer systems of Examples 36-40 according to the formulas in Table 8.

TABLE 8

| | Ex. 41 | Ex. 42 | Ex. 43 | Ex. 44 | Ex. 45 |
|---|---|---|---|---|---|
| | % wt. | % wt. | % wt. | % wt. | % wt. |
| Elastomer System of Ex. 36 | 33.00 | — | — | — | — |
| Elastomer System of Ex. 37 | — | 33.00 | — | — | — |
| Elastomer System of Ex. 38 | — | — | 33.00 | — | — |
| Elastomer System of Ex. 39 | — | — | — | 33.00 | — |
| Elastomer System of Ex. 40 | — | — | — | — | 33.00 |
| Sorbitol | 56.00 | 56.00 | 56.00 | 56.00 | 56.00 |
| Maltitol | 2.00 | 2.00 | 2.00 | 2.00 | 2.00 |
| Triacetin | 1.00 | 1.00 | 1.00 | 1.00 | 1.00 |
| Lecithin | 0.50 | 0.50 | 0.50 | 0.50 | 0.50 |
| Glycerin | 5.00 | 5.00 | 5.00 | 5.00 | 5.00 |
| Peppermint Flavor | 2.00 | 2.00 | 2.00 | 2.00 | 2.00 |
| High Intensity Sweetener | 0.50 | 0.50 | 0.50 | 0.50 | 0.50 |
| Total | 100.00 | 100.00 | 100.00 | 100.00 | 100.00 |

The gums of Examples 41 to 45 were mixed, sheeted and pelletized with no processing problems.

Selected Examples and Comparative Runs were tested for removability in the manner previously described. The results are given in Table 9.

TABLE 9

| Example/ | | Residue | |
|---|---|---|---|
| Comparative | Residue | % Standard | |
| Run # | (Area %) | Deviation | N |
| Ex. 19 | 15 | 15 | 5 |
| Ex. 28 | 0 | 0 | 4 |
| Ex. 29 | 8 | 18 | 5 |
| Ex. 30 | 9 | 20 | 5 |
| Ex. 31 | 1 | 1 | 5 |
| C.R. 32 | 99 | 2 | 3 |
| Ex. 41 | 3 | 0 | 2 |
| Ex. 42 | 0 | 0 | 2 |
| Ex. 43 | 15 | 16 | 2 |
| Ex. 45 | 4 | 6 | 2 |
| Ex. 46 | 7 | 0 | 2 |

1. A chewing gum base which is cud-forming and chewable at mouth temperature comprising a food acceptable tri-block copolymer in the form A-B-A or A-B-C having a soft mid-block and hard end-blocks wherein the soft mid-block comprises at least 30 wt. % of the tri-block copolymer and wherein the hard end-blocks each have a Tg below 70° C.

2. A gum base of claim 1 further comprising a di-block copolymer.

3. A gum base of claim 1 wherein the gum base comprises at least one additional ingredient selected from the group consisting of plasticizers, softeners, emulsifiers, fillers, plastic resins, colors, anti-oxidants and additional elastomers.

4. The gum base of claim 3 wherein the gum base comprises 0 to 5% of talc or calcium carbonate filler.

5. The gum base of claim 3 wherein the gum base comprises 5 to 40% amorphous silica filler.

6. The gum base of any of claim 3 wherein the base comprises 5 to 15% high molecular weight polyisobutylene.

7. A gum base of claim 1 wherein the soft mid-block comprises at least 40 wt. % of the tri-block copolymer.

8. The chewing gum of claim 7 wherein the soft mid-block comprises at least 50 wt. % of the tri-block copolymer.

9. The chewing gum of claim 7 wherein the soft mid-block comprises at least 60 wt. % of the tri-block copolymer.

10. A gum base of claim 1 wherein the hard end-blocks have a Tg below 60° C.

11. A gum base of claim 1 wherein the hard end-blocks have a Tg between 20° C. and 70° C.

12. A gum base of claim 1 wherein the hard end-blocks have a Tg between 20° C. and 60° C.

13. A gum base of claim 1 wherein the hard end-blocks have a Tg between 30° C. and 70° C.

14. A gum base of claim 1 wherein the hard end-blocks have a Tg between 30° C. and 60° C.

15. A gum base of claim 1 wherein the hard end-blocks have a Tg between 40° C. and 70° C.

16. A gum base of claim 1 wherein the hard end-blocks have a Tg between 40° C. and 60° C.

17. A gum base of claim 1 wherein the hard end-blocks comprise one or more polymers selected from the group consisting of poly(D,L-lactide), polyvinylacetate, polyethylene terephthalate, polyglycolic acid, random copolymer of glycolic acid and D,L lactide, and alternating copolymer of glycolic acid and D,L lactide.

18. A gum base of claim 17 wherein at least one of the hard end-blocks comprises poly(D,L-lactide).

19. A gum base of claim 1 wherein the soft mid-block comprises a polymer selected from the group consisting of polyisoprene, poly(6-methylcaprolactone), poly(6-butyl-ε-caprolactone (also known as poly(ε-decalactone), other polymers of alkyl or aryl substituted-caprolactones, polydimethylsiloxane, polybutadiene, polycyclooctene, polyvinyllaurate, polyethylene oxide, polyoxymethylene, polymenthide, polyfarnesene and polymyrcene.

20. A gum base of claim 19 wherein the soft mid-block comprises polyisoprene.

21. A gum base of claim 19 wherein the soft mid-block comprises poly(6-methylcaprolactone).

22. A gum base of claim 1 wherein the gum cud is readily removable when adhered to concrete.

23. A gum base of claim 1 wherein the tri-block copolymer is environmentally degradable.

24. A gum base of claim 1 wherein the tri-block copolymer is produced from renewable resources.

25. A gum base of claim 1 wherein the tri-block copolymer is food grade.

26. A chewing gum comprising the gum base of claim 1.

27. The chewing gum of claim 26 wherein the chewing gum comprises 3 to 7% of an emulsifier by weight of the chewing gum composition

28. The chewing gum of claim 27 wherein at least a portion of the emulsifier is spray dried or encapsulated.

29. The chewing gum of claim 27 wherein the emulsifier is lecithin.

30. The chewing gum of claim 27 wherein the chewing gum further comprises an enzyme capable of degrading at least one polymer in the chewing gum.

31. The chewing gum of claim 30 wherein the enzyme is encapsulated.

32. The chewing gum of claim 26 further comprising a polymer having a straight or branched chain carbon-carbon polymer backbone and a multiplicity of side chains attached to the backbone.

33. The chewing gum of claim 32 wherein the polymer having a straight or branched chain carbon-carbon polymer backbone and a multiplicity of side chains attached to the backbone is present in the gum base.

34. The chewing gum of claim 26 further comprising a polymer comprising hydrolyzable units or an ester and/or ether of a polymer comprising hydrolyzable units.

35. The chewing gum of claim 34 wherein the polymer comprising hydrolyzable units or the ester and/or ether of a polymer comprising hydrolyzable units is present in the gum base.
